(19) United States
(12) Patent Application Publication
(10) Pub. No.: US 2008/0266639 A1
(43) Pub. Date: Oct. 30, 2008

(54) Optical Device Based on a Three-Arm Mach-Zehnder Interferometer

(76) Inventors: Andrea Melloni, Milano (IT); Francesco Morichetti, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/587,636

(22) PCT Filed: Apr. 30, 2004
(86) PCT No.: PCT/EP2004/050663

§ 371 Date: Oct. 26, 2006

(51) Int. Cl. G02F 1/225

(52) U.S. Cl. 359/241

(57) ABSTRACT

An optical device includes an interferometer having a first optical coupler, a second optical coupler and at least three arms optically coupling the first optical coupler to the second optical coupler; and a phase-shifting arrangement associated with the arms, at least one among the first and second optical couplers including a first optical input port, two first optical output ports and a second optical output port. An optical power coupling is implemented such that optical power received at the first optical input port is coupled, a first fraction into each of the first optical output ports, and a second fraction into the second optical output port. The at least one among the first and second optical couplers further includes a second optical input port and a third optical input port, and the at least one among the first and second optical couplers implements an optical power coupling such that optical power received at either one of the first or second optical input ports is coupled, the first fraction into each of the first optical output ports, and the second fraction into the second optical output port, whereas optical power received at the third optical input port is coupled, a third fraction into each of the first optical output ports, and a fourth fraction into the second optical output port, wherein the first fraction is different from the third fraction.

The present invention generally relates to optical devices, particularly integrated optics devices. More specifically, the invention concerns optical devices based on Mach-Zehnder Interferometers (hereinafter shortly referred to as MZIs).

The MZI is a basic building block of several optical devices, both in fiber and in integrated optics. The most commonly known MZIs are two-arms devices, with an input two-ways optical coupler, acting as a power splitter and splitting the power of an input optical signal into the two arms of the MZI, and an output two-ways optical coupler, acting as an optical power combiner, at which the two interferometer arms rejoin and that interferometrically recombines the optical power.

Two-arms MZIs can for example be used for realizing optical interleavers, optical add/drop multiplexers, thermo- or electro-optical switches or modulators, Variable Optical Attenuators (VOAs), all-optical wavelength converters, just to cite some.

Optical devices realized using two-arms MZIs are satisfactory under many respects, mainly because of their simplicity and ease of fabrication.

Despite of this, the Applicant has however observed that the performance of these devices is not particularly good.

In particular, the Applicant has observed that the performance of optical devices based on two-arms MZIs is significantly affected even by relatively small variations in optical power splitting ratio of the two two-ways optical couplers of the MZIs, variations caused by inevitable tolerances in the fabrication processes.

Additionally, the Applicant has observed that in devices such as optical interleavers and add-drop multiplexers, problems of cross-talks between adjacent channels of a Wavelength Division Multiplexed (WDM) signal may arise.

In view of the state of the art outlined in the foregoing, it has been an object of the present invention to provide an optical device structure capable of overcoming the limitations and providing improved performance with respect to the known optical devices based on two-arms MZIs.

With this object in mind, the Applicant has found that using three-arm MZIs, instead of the usual two-arm MZIs, several benefits can be achieved.

The Applicant observes that optical devices based on MZIs having more than two arms (so-called generalized MZIs) have already been proposed, particularly three-arms MZIs in fiber optic technology.

For example, U.S. Pat. No. 6,204,951 B1 describes an electro-optic modulator based on a three-arm MZI for use in the context of analogue amplitude modulation of a CATV (Cable Teleision) signal.

As another example, in EP 1 217 425 A1, an optical intensity modulator using a three-arm MZI is described. The modulator comprises an input/output waveguide, extending continuously so as to form a central arm of the three-arm MZI, adapted to receiving an input optical power (the signal to be modulated) and to deliver an output optical power (the modulated signal); two external waveguides, forming the external arms of the MZI, which extend from an input signal divider to an output signal combiner, and a cascaded DC and AC electrodes structures associated with the MZI arms. The input signal divider, constituted by a three-way coupler, splits the input optical power received through the input waveguide into the three arms of the MZI, with a power splitting ratio such that 50% of the input optical power is coupled into the central arm, while 25% of the input optical power is coupled into each of the two external arms of the MZI. The output signal combiner is also constituted by a three-way coupler.

The modulator described in the cited document thus has one input optical port (the input waveguide), one output optical port (the output waveguide), two monitoring optical ports (the extensions of the external waveguides out from the output signal combiner), used to convey a feedback signal for controlling the bias of the DC electrode structure.

The cited document does not explicitly mention the characteristics of the three-way coupler forming the input signal divider of the modulator. However, in that document a discussion is provided of the effects on the device characteristics of varying the coupler power splitting ratio: 40:20:40, 33:33:33 and 25:50:25.

The Applicant observes that such power splitting ratios, according to which the input optical power, received at the input waveguide, is coupled an equal fraction (40%, 33% and 25%) into each of the lateral arms of the modulator, can only be achieved if the coupler has a normalized coupling length of 0.25 (a normalized coupling length equal to 1 corresponding to a length of the coupling region for which the optical power received at the input waveguide is entirely coupled back onto the input waveguide).

In such a coupler, if the input optical power were received not at the central input port of the coupler, but at either one of the two other input ports, a different fraction of the optical power would be coupled into each of the three interferometer arms.

A three-arm interferometer optical modulator is also described in U.S. Pat. No. 6,393,166 B1. In this case, the modulator is comprised of an input optical waveguide, having first, second and third arms branching off therefrom, and then recombining together in a spaced-apart position, so that an optical field is transmitted through the optical waveguide including the three arms. Coplanar waveguide electrodes are formed on the three arms.

In G. Weihs et al, “All-fiber three-path Mach-Zehnder interferometer”, Optics Letters, Vol. 21, No. 4, Feb. 15, 1996, pages 302-304, a three-arm MZI is disclosed made of single-mode optical fibers, and wherein the phase modulation in the three arms is induced by piezoceramics. The device is particularly intended for applications in the field of interferometric measurements and quantum physics.

The Applicant however has found that several practical optical devices having superior performance can be realized based on a novel three-arm MZI in which two three-way optical couplers are used, and wherein at least one of the couplers, possibly both, implements peculiar optical power coupling factors, differing from each other depending on which optical input port receives the optical power, for example 25%/50%/25% for an optical power received at either one of two optical input ports, and 50%/0/50% for an optical power received at the other optical input port.

Thus, according to an aspect of the present invention, an optical device as set forth in appended claim 1 is provided.

The optical device comprises:

an interferometer including a first optical coupler, a second optical coupler and at least three arms, optically coupling the first optical coupler to the second optical coupler; a phase-shifting arrangement is associated with said arms.

At least one among the first and second optical couplers comprises a first optical input port, two first optical output ports and a second optical output port, and implements an optical power coupling such that an optical power received at the first optical input port is coupled a first fraction into each of the first optical output ports, and a second fraction into the second optical output port.

Said at least one among the first and second optical couplers further comprises a second optical input port and a third optical input port, and implements an optical power coupling such that an optical power received at either one of the first or second optical input ports is coupled the first fraction into each of the first optical output ports, and the second fraction into the second optical output port, whereas an optical power received at the third optical input port is coupled a third fraction into each of the first optical output ports, and a fourth fraction into the second optical output port, wherein the first fraction is different from the third fraction.

In particular, the second fraction is different from the fourth fraction.

In an embodiment of the present invention, said third fraction is substantially 50% and said fourth fraction is substantially 0%, whereby an input optical power received at the third optical input port causes substantially equal optical power at the first optical output ports, and substantially zero optical power at the second optical output port

In a preferred embodiment of the present invention, said first fraction is substantially 25% and said second fraction is substantially 50%.

In particular, each of said first and second optical couplers is bidirectional, whereby a generic input optical port, is also, adapted to act as an output optical port, and vice versa, a generic output optical port is also adapted to act as an input optical port, preserving the optical power coupling.

Preferably, each of the first and second optical couplers is designed in such a way that a phase difference between optical fields at the first optical output ports is substantially equal to π, whereas a phase difference between an optical field at either one of the first optical output ports and an optical field at the second optical output port is approximately equal to π/2.

Even more preferably, each of the first and second optical couplers is designed in such a way that the amplitude and the phase of optical fields at the output ports of the coupler are related to those of the optical fields at the input ports by the expression:

$$( \begin{matrix}\frac{1}{2} & \frac{j}{\sqrt{2}} & - \frac{1}{2} \\ \frac{j}{\sqrt{2}} & 0 & \frac{j}{\sqrt{2}} \\ - \frac{1}{2} & \frac{j}{\sqrt{2}} & \frac{1}{2}\end{matrix} ) .$$

Said at least three arms may includes a first and a second arms, coupling a respective one of the two first optical outputs of the first optical coupler to a respective one of the two first optical inputs of the second optical coupler, and a third arm, coupling the second optical output of the first optical coupler to the second optical input of the second optical coupler; said phase-shifting arrangement may include, associated with each one of the first, second and third arms, a respective first, second and third phase shifter, introducing a respective first, second and third phase shift on the component of the input optical signal propagating therethrough.

In an embodiment of the present invention, each phase shifter includes a respective optical waveguide section of prescribed optical length. In particular, the optical waveguide sections forming the phase shifters may have mutually different optical length.

Even more particularly, the optical lengths of the optical waveguide sections are such that the first phase shift is lower than the third phase shift, which is in turn lower than the second phase shift, a difference between the third and the first phase shifts being substantially equal to a difference between the second and third phase shifts.

At least one optical ring resonator may be provided for, optically coupled to at least one of said optical waveguide sections. In particular, the at least one optical ring resonator may be optically coupled to the respective waveguide section through a two-way directional coupler.

The at least one optical ring resonator may in particular be optically coupled to the waveguide section in the third arm, or said at least one optical ring resonator may include at least one optical ring resonator optically coupled to each one of the waveguide sections of the first, second and third arms. The at least one optical ring resonator may even include at least one series or parallel arrangement of a plurality of optical ring resonators, optically coupled to the at least one of waveguide section.

In an embodiment of the present invention, at least one of said phase shifters includes a Bragg grating formed within the respective waveguide section. Said Bragg grating preferably has a period such that the grating substantially reflects optical wavelengths in a prescribed band.

In an embodiment of the present invention, at least one of said phase shifters includes a controlled heater associated with the respective waveguide section for causing a change in a refractive index of the waveguide section by thermo-optic effect. Said controlled heater may comprise an electric conductor thermally coupled to the waveguide and adapted to received a controlled electric power supply.

In an embodiment of the present invention, at least one of said phase shifters includes, associated with the respective optical waveguide section, an electrodes structure adapted to induce a change in the refractive index of the waveguide by electro-optic effect.

In an embodiment of the present invention, at least one of said phase shifters includes, associated with the respective optical waveguide, a free charge carrier concentration modulation arrangement, adapted to induce a change in a refractive index of the waveguide by plasma-dispersion effect.

At least one of said phase shifters may have the respective waveguide section at least partially made of a non-linear material.

The phase shifter may include a semiconductor optical amplifier.

The features and advantages of the present invention will be made apparent by the following detailed description of some embodiments thereof, provided merely by way of non-limitative examples, description that will be conducted making reference to the annexed drawings, wherein:

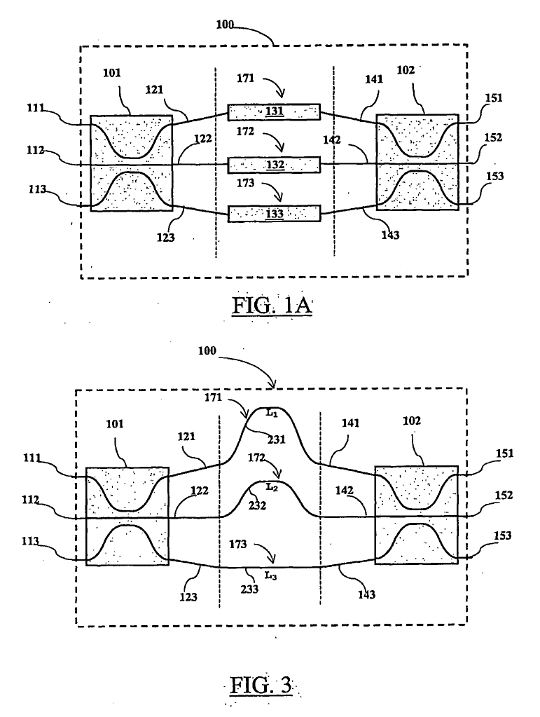

FIG. 1A schematically shows a general scheme of an optical device based on a three-arm MZI according to an embodiment of the present invention, having three input ports and three output ports;

FIGS. 1B and 1C are diagrams showing optical power coupling factors in correspondence of the three output ports of a three-way directional coupler exploited in the three-arm MZI of FIG. 1A, for an optical power received at either one of two first input ports (FIG. 1B), and at a second input port (FIG. 1C);

FIG. 2A schematically shows m greater detail the structure of the three-way directional coupler, according to an embodiment of the present invention;

FIG. 2B shows in greater detail the structure of the three-way directional coupler, according to another embodiment of the present invention;

FIG. 2C shows in greater detail the structure of the three-way directional coupler, according to still another embodiment of the present invention;

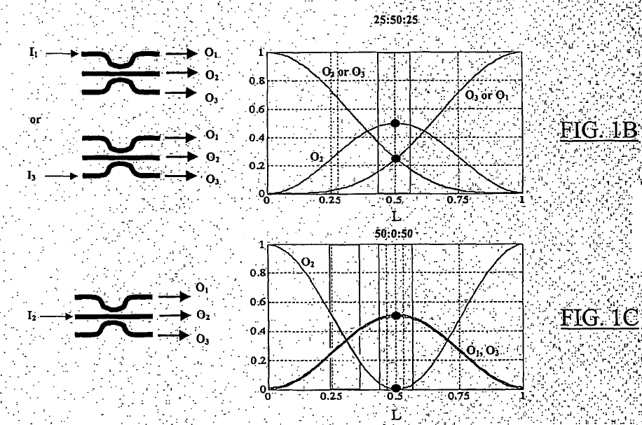

FIG. 3 schematically shows a first type of optical device based on the general device scheme of FIG. 1A, including in the three arms of the MZI three optical waveguides of different optical length acting as phase shifters, particularly adapted to act as an optical interleaver;

FIG. 4A schematically shows the behavior of an ideal optical interleaver, which receives a WDM optical comprising several channels at different wavelengths;

FIG. 4B sketchily shows spectra of two output WDM optical signals exiting from the ideal optical interleaver of FIG. 4a;

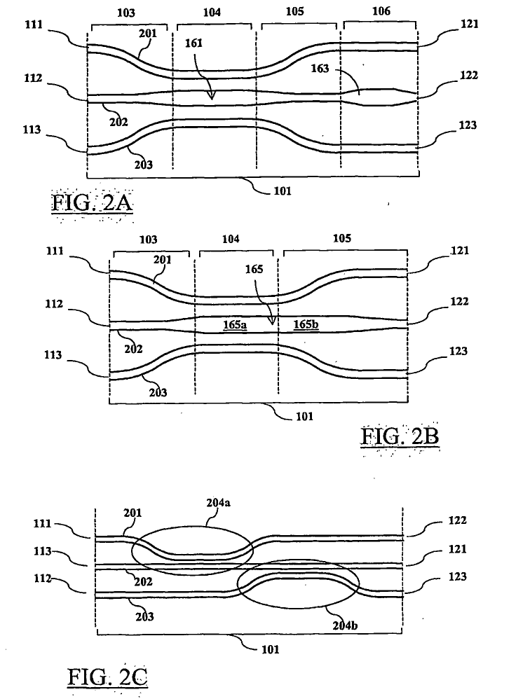

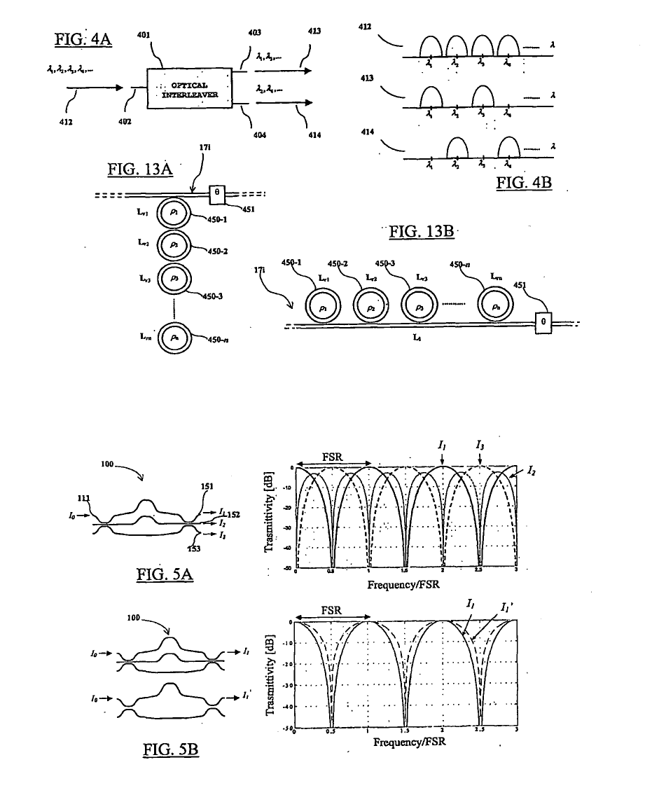

FIG. 5A shows, in diagrammatic form, an intensity transfer function at the three output ports of the device of FIG. 3 when the input optical power is supplied at a prescribed one of the three input ports thereof;

FIG. 5B shows, in diagrammatic form, a comparison between the intensity transfer function of the device of FIG. 3 and an intensity transfer function of a similar device based on a conventional two-arm MZI;

FIGS. 6A, 6B and 6C show in diagrammatic form the impact of fabrication tolerances on the intensity transfer function of the optical device of FIG. 3, compared to the impact of fabrication tolerances on the intensity transfer function of the device based on the two-arm MZI;

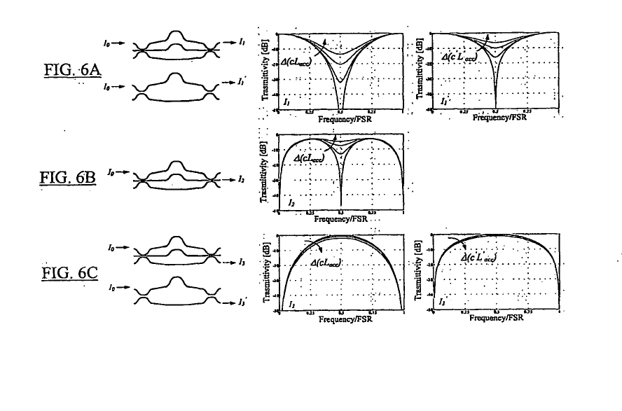

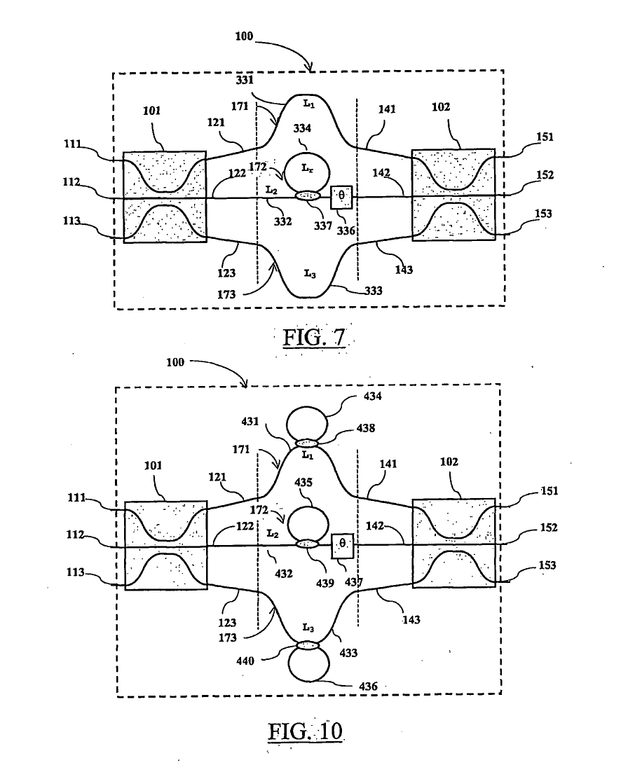

FIG. 7 schematically shows a second type of optical device based on the general scheme of FIG. 1A, also adapted to be used as an interleaver, including an optical microring resonator coupled to the central arm of the device;

FIG. 8A shows in diagrammatic form the intensity transfer function at the three output ports of the device of FIG. 7 when the input power is supplied at a prescribed one of the three input ports thereof;

FIG. 8B shows in diagrammatic form the comparison between an intensity transfer function of the device of FIG. 7 and that of the device of FIG. 3;

FIGS. 9A, 9B and 9C show in diagrammatic form the impact of fabrication tolerances on the intensity transfer function of the device of FIG. 7 compared to the impact of fabrication tolerances on an intensity transfer function of a similar, optical ring-based two-arm MZI;

FIG. 10 schematically shows a third type of optical device based on the general scheme of FIG. 1A, again adapted to be used as an interleaver including an optical microring resonator coupled to each arm of the device;

FIG. 11A shows in diagrammatic form an intensity transfer function at the three output ports of the device of FIG. 10 when the input power is supplied at a prescribed one of the three input ports thereof;

FIG. 11B shows in diagrammatic form the comparison between the intensity transfer function of the device of FIG. 10 and that the device of FIG. 7;

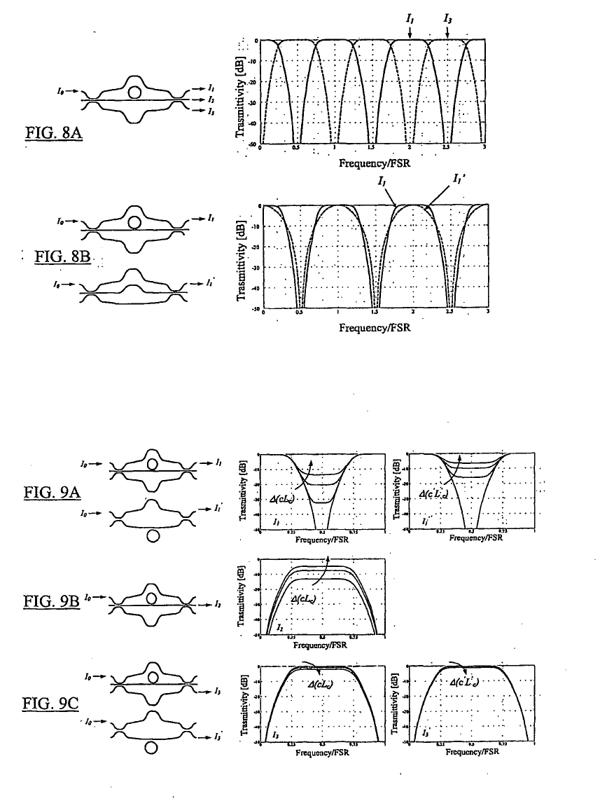

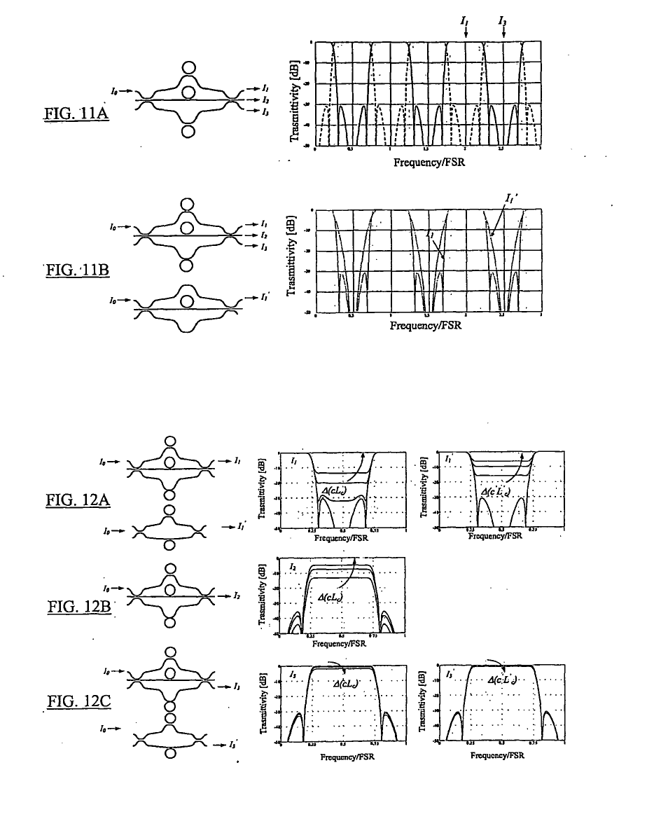

FIGS. 12A, 12B and 12B show in diagrammatic form the impact of fabrication tolerances on the intensity transfer function of the device of FIG. 11, compared to the impact of fabrication tolerances on an intensity transfer function of a similar optical ring-based two-arm MZI;

FIGS. 13A and 13B schematically show a general parallel arrangement and, respectively, a general series arrangement of a plurality of ring-based phase shifters that can be introduced in each arm of the devices of FIGS. 7 and 10;

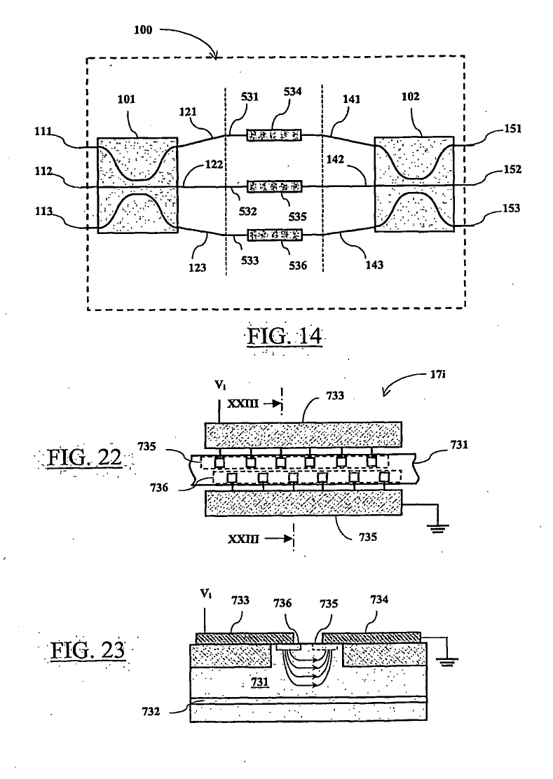

FIG. 14 schematically shows a fourth type of optical device based on the general scheme of FIG. 1A, including a Bragg grating in each arm of the device, adapted to be used as an add/drop optical multiplexer;

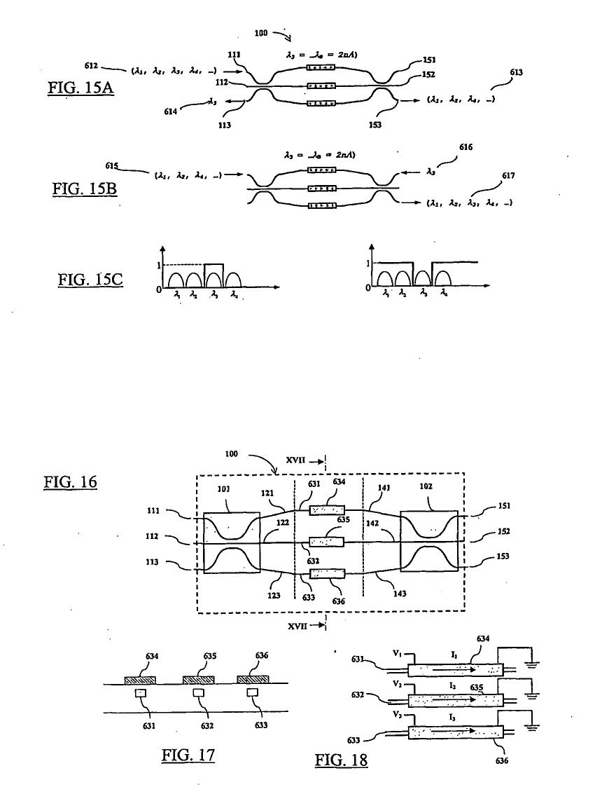

FIG. 15A schematically shows the behavior of the device of FIG. 14 operated as a drop optical multiplexer, when an input WDM optical signal comprising several channels at different wavelengths is supplied at a prescribed one of the three input ports thereof;

FIG. 15B schematically shows the behavior of the device of FIG. 14 operated as an add optical multiplexer, when an input WDM optical signal comprising several channels at different wavelengths is supplied at a prescribed one of the three input ports thereof, and an additional channel is supplied at another input port;

FIG. 15C schematically, shows sketches of a spectral response of an ideal add-drop multiplexer.

FIG. 16 schematically shows a fifth type of optical device based on the general scheme of FIG. 1A, in which a DC electrode structure is associated with the three MZI arms for thermo-optically inducing a variable phase shift of the optical field in the three arms of the device;

FIG. 17 schematically shows the cross section of the device of FIG. 16 taken along the line XVII-XVII;

FIG. 18 schematically shows the top view of the device of FIG. 16 in the region containing the electrodes;

FIG. 19 schematically shows a sixth type of optical device based on the general scheme of FIG. 1A, in which a different DC electrode structure is associated with the MZI arms for electro-optically inducing a variable phase-shift of the optical field in the three arms of the device;

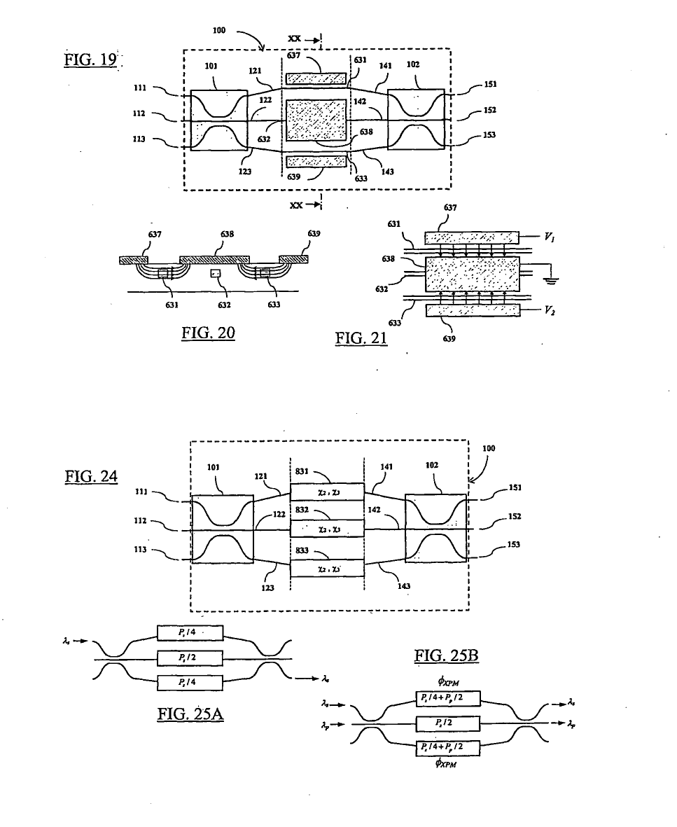

FIG. 20 schematically shows the cross section of the device of FIG. 19 along the line XX-XX;

FIG. 21 schematically shows the top plan view of the device of FIG. 19 in the region containing the electrodes.

FIG. 22 schematically shows in top plan view a phase shifter based on the plasma dispersion effect in a semiconductor material, which can be included in each arm of an optical device based on the general scheme of FIG. 1A, according to a seventh embodiment of the present invention;

FIG. 23 schematically shows the cross section of the phase shifter of FIG. 22 taken along the line XXIII-XXIII;

FIG. 24 schematically shows an eighth type of optical device based on the general scheme of FIG. 1A, comprising nonlinear optical waveguides in the MZI arms;

FIG. 25A schematically shows the behavior of the device of FIG. 24 when only a low power optical signal is supplied at a prescribed one of the three input ports of the device;

FIG. 25B schematically shows the behavior of the device of FIG. 24 when a low power signal is supplied at a prescribed one of the three input ports of the device and an intense signal, acting as a pump, is supplied at the same time at another prescribed input port of device;

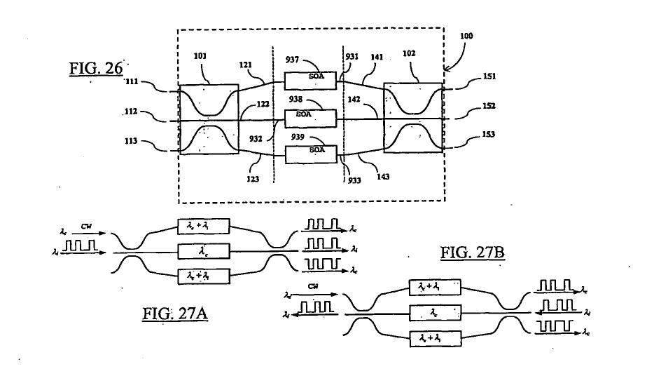

FIG. 26 schematically shows a ninth type of optical device based on the general scheme of FIG. 1A, including a semiconductor optical amplifier (SOA) in each arm of the interferometer;

FIG. 27A schematically shows an application of the device of FIG. 26 as a wavelength converter when the signal wave and the converted wave are co-propagating inside the device; and

FIG. 27B schematically shows an application of the device of FIG. 26 as a wavelength converter when the signal wave and the converted wave are counter-propagating inside the device.

Referring to FIG. 1A, a general scheme of an optical device 100 according to an embodiment of the present invention, based on a three-arm generalized MZI is schematically shown.

The optical device 100 comprises a first three-way directional coupler 101, arranged to receive and split an input optical power of an input optical field, received at one of three optical input ports 111, 112 and 113 (forming the input ports of the device 100), into three output optical fields, made available at three optical output ports 121,122 and 123 thereof.

The three output ports 121, 122 and 123 of the first three-way coupler 101 are each one associated with a respective one of three arms 171, 172 and 173 of the MZI. In the drawing, each interferometer arm 171, 172 and 173 is depicted as including a respective optical device 131, 132 and 133. In principle, the optical devices 131, 132 and 133 are generic optical devices; any kind of optical device can be exploited, from a simple optical waveguide section of suitably chosen length to a very complex device; the specific type of optical device used is not limitative to the present invention. In the following of this description, several devices according to different embodiments of the present invention will be presented, differing from each other in the type of the optical devices 131, 132 and 133. Depending on the type of optical device used in the interferometer arms, the device 100 may be adapted to perform particular functions.

Each interferometer arm 171, 172 and 173 is also associated with a respective optical input port 141, 142 and 143 of a second three-way directional coupler 102, acting as an optical power combiner. Thus, each optical output port of the first three-way coupler 101 is optically coupled, by means of a respective interferometer arm 171, 172 and 173, to a respective optical input port of the second three-way coupler 102.

The second three-way directional coupler 102 has three optical output ports 151, 152 and 153, forming the output ports of the optical device 100.

Advantageously, the two three-way directional couplers 101 and 102 are substantially identical to each other in structure and behavior.

According to an embodiment of the present invention, each of the first and second three-way directional couplers 101, 102 is such that an input optical power received at either one of the two optical input ports, e.g. one of the ports 111, 113 of the coupler 101, is coupled a first fraction into each of the optical output ports 121 and 123, and a second fraction into the optical output port 122, whereas an optical power received at the optical input port 112 is coupled a third fraction into each of the optical output ports 121 and 123, and a fourth fraction into the optical output port 122.

Preferably, the first and second fractions are equal to approximately 25% and approximately 50%, respectively. More preferably the third and fourth fractions are equal to approximately 50% and approximately 0%, respectively. It is pointed out that, in the context of the present description, and for the purposes of the present invention, the above-mentioned optical power coupling fraction values are to be intended to be equal to the cited values with approximately a 20% tolerance.

According to a preferred embodiment of the present invention, the couplers 101 and 102 are designed in such a way that the amplitude and the phase of the optical fields at the output ports 121, 122, 123 and 151, 152, 153 of each coupler are related to the optical fields at the input ports 111, 112, 113 and 141, 142, 143 of the same coupler by the following expression (hereinafter referred to as eq.(1)):

$$( \begin{matrix}{b}_{1} \\ {b}_{2} \\ {b}_{3}\end{matrix} ) = ( \begin{matrix}\frac{1}{2} & \frac{j}{\sqrt{2}} & - \frac{1}{2} \\ \frac{j}{\sqrt{2}} & 0 & \frac{j}{\sqrt{2}} \\ - \frac{1}{2} & \frac{j}{\sqrt{2}} & \frac{1}{2}\end{matrix} ) ( \begin{matrix}{a}_{1} \\ {a}_{2} \\ {a}_{3}\end{matrix} ) .$$

where α₁, α₂ and α₃ are the optical fields at the input ports 111, 112 and 113, respectively, of the first coupler 101, and at the input ports 141, 142 and 143, respectively, of the second coupler 102, and b₁, b₂ and b₃ are the optical fields at the output ports 121, 122 and 123, respectively, of the first coupler 101, and at the output ports 151, 152 and 153, respectively, of the second coupler 102.

Let reference be made to FIGS. 1B and 1C, which represent diagrams showing the variation of the optical power coupled into each one of the three output ports with the normalized coupling length L, depending on whether the input optical power is received at the input ports 111 or 113 (FIG. 1B), or at the input port 112 (FIG. 1C). A coupler according to the present invention has a normalized coupling length L of approximately 0.5. A section of the diagrams of FIGS. 1B and 1C, for values along the x axis within a range of L=0.5±0.05 is represented as shaded in FIGS. 1B and 1C. This range of values for the normalized coupling length L approximately corresponds to power coupling fraction values within a 20% tolerance range from optimum values.

Let it be assumed that an optical field is fed to the first coupler 101 through one of the input ports 111 or 113 (this situation is depicted in FIG. 1B, where the input optical power is identified as I₁ or I₃). From eq. (1) it can be derived that when α₁=1, α₂=0 and α₃=0, or when α₁=0, α₂=0 and α₃=1, the coupler 101 splits 50% of the optical power into the output port 122 thereof (curve O₂ in FIG. 1B), and 25% of the input power into each of the two output ports 121 and 123 (curves O₁ and O₃ in FIG. 1B). Similarly, the optical power of an optical field fed to the second directional coupler 102 through one of the input ports 141 or 143 is split 50% into the output port 152, and 25% of the input power into each of the two output ports 151 and 153.

Differently (FIG. 1C), if an optical field is fed to the first coupler 101 through the input port 112 (α₂=1, α₁=α₃=0), the coupler 101 splits 50% of the optical power into each of the output ports 121 and 123, and substantially 0% of die optical power is made available at the output port 122. Similarly, if an optical field is fed to the second coupler 102 through the input port 142, the coupler 102 splits 50% of the optical power into each of the output ports 151 and 153, and substantially 0% of the optical power is made available at the output port 152.

As far as the optical field phase is concerned, a n phase difference exists between the optical fields at the output ports 121 and 123 of the first coupler 101, and between the optical fields at the output ports 151 and 153 of the second coupler 102, while the phase difference between the optical field at either one of the output ports 121 and 123 and the optical field at the output port 122 of the first coupler 101, and between the optical field at either one of the output ports 151 and 153 and the optical field at the output port 152 of the second coupler 102, is equal to π/2. The Applicant observes that the phase shift introduced by the couplers 101 and 102 is a critical parameter, which has to be taken into careful consideration in the design of the optical device 100. In particular, as it will be made clearer in the following of the present description, the transfer function of the optical device 100 strongly depends on how the phase shift introduced by the couplers 101 and 102 combines with the phase shift induced by the optical devices 131, 132 and 133 in the interferometer arms 171, 172 and 173. It is however observed that the optical couplers 101 and 102 might be such that the above-mentioned phase differences take different values, provided that account is taken for this fact in the design of the optical devices 131, 132 and 133.

From eq.(1), it can also be assumed that, at least as far as the optical power splitting (optical field amplitude) is concerned, the two optical couplers 101 and 102 are symmetrical, i.e., the optical input ports 111, 112, 113 and 141, 142, 143 and the optical output ports 121, 122, 123 and 151, 152, 153 are interchangeable.

From a practical viewpoint, the three-way optical couplers 101 and 102 can be realized by means of a suitable spatial arrangement and design of three waveguides. Different waveguide designs and arrangements, are possible; for example, FIGS. 2A, 2B and 2C schematically show in greater detail three alternative embodiments of the three-way optical coupler 101, all adapted to satisfy the relation written in eq. (1).

In particular, referring to FIG. 2A, the optical coupler 101 comprises three waveguides 201, 202 and 203, extending through the coupler from the input ports 111, 112, 113 to the output ports 121, 122, 123, respectively. Four different regions can be identified: a first transition region 103, proximate to the input ports 111, 112 and 113, followed by a coupling region 104, a second transition region 105 and a rephasing region 106. In the first transition region 103 the three input waveguides, which are at relatively large distance and hence not optically coupled at the input ports 111, 112 and 113, get progressively closer to each other; for example, the two external waveguides 201 and 202 curve and approach the central waveguide 202, extending substantially straight through the coupler. In the coupling region 104, the distance between the three waveguides 201, 202, 203 is reduced to an extent such that the optical mode of each waveguide partially and properly overlaps to the optical mode of the adjacent waveguide(s); the extension of the coupling region shall be such as to cause a sufficient coupling of optical modes between the waveguides. In the second transition region 105, the distance between the three coupled waveguides 201, 202, 203 progressively increases, so that, at the end of the region 105, the three waveguides 201, 202, 203 are no more optically coupled.

In order to make the optical fields at the exit of the coupler 101 have phase and power satisfying eq.(1), the optical fields propagating in the three waveguides 201, 202, 203 in the coupling region 104 should observe a substantially identical effective refractive index. However, the presence of one or more waveguides adjacent to and optically coupled to a given waveguide generally introduces a mutual loading effect which slightly affects the waveguide effective refractive index. In the embodiment of coupler 101 shown in FIG. 2A, the central waveguide 202 has two adjacent waveguides 201 and 203 that are optically coupled thereto, whereas each external waveguide 201, 203 has just one adjacent and optically coupled waveguide, namely the central waveguide 202, so that the effective refractive index perturbation is different in the external waveguides 201, 203 compared to the central waveguide 202. To compensate the effect given by the adjacent waveguides, a slightly widened waveguide portion 161 is provided in the central waveguide 202 in the coupling region 104 (alternatively, the waveguide width may be slightly reduced), so as to match the effective refractive index observed by the external waveguides 201, 203. In the second transition 105 region, the external waveguides 201, 203 preferably diverge in a symmetrical way with respect to an axis of the central waveguide 202, so that the optical path of the optical fields propagating through the waveguides 201, 203 is substantially identical, and the it phase difference between the optical fields at the external output ports 121 and 123 is maintained still at the end of the second transition region. The central waveguide 202, being straight, has an optical length different from that of the external waveguides 201, 203. The rephasing region 106 is provided for achieving the desired π/2 phase difference between the optical field in the central waveguide and those in two external waveguides. The rephasing is obtained by providing in the waveguide 202 another slightly widened (alternatively, a slightly narrowed) waveguide section 163. It is observed that in the rephasing region 106 the three waveguides 201, 202, 203 are not optically coupled, and the central waveguide tapering 163 only affects the effective refractive index of the central waveguide 202. The length and width of the two tapered regions 161 and 163 depend both on waveguide parameters such as refractive index difference, waveguide shape and dimension and the like, and on coupler parameters (such as the distance between the coupled waveguides, the length of the coupling region 104, the waveguide bend radii etc.).

FIG. 2B schematically shows a directional coupler 101 according to an alternative embodiment of the present invention, in which the central waveguide 202, again extending straightly through the coupler, has a single widened (or, alternatively, narrowed) waveguide portion 165. A first portion 165a of the widened waveguide portion 165 extends along the coupling region 104 and balances the effective refractive index difference between the central waveguide 202 and the external waveguides 201, 203, due to the adjacent waveguide loading effect A second portion 165b of the of the widened waveguide portion 165 extends along the second transition region 105 and balances the optical path difference between the central, straight waveguide 202 and the external, curved waveguides 201, 203. No rephasing region is provided.

FIG. 2C schematically shows a three-way optical coupler 101 according to still another alternative embodiment of the present invention. As in the previous two embodiments, the optical coupler 101 comprises a central waveguide 202, extending substantially straight through the coupler, and two waveguides 201, 203 arranged laterally to the central waveguide 202. The three-way coupler according to this embodiment substantially is a cascade of two two-way couplers: a first two-way coupler 204a is formed by the waveguides 201 and 202, a second two-way coupler 204b, in the drawing located downstream the first two-way coupler, is formed by the waveguides 202 and 203. If the power splitting ratio of each two-arm coupler 204a, 204b is 50:50 and the optical length of the waveguides 201, 202, 203 is properly chosen, so as to satisfy the desired condition concerning the optical field relative phase at the output ports 121, 122, 123 of the coupler (if necessary, suitable phase shifters can be exploited for ensuring that the condition is satisfied), the transfer function of the device of FIG. 2C coincides with the transfer function of the three-arm couplers of FIGS. 2A and 2B, i.e. with the eq.(1). It is pointed out that a difference (practically, the only one) between the coupler of FIG. 2C and those of FIGS. 2A and 2B is that the spatial order of the coupler output ports changes: the output port 122 receiving 50% of the power of an optical field fed to the coupler through either one of the input ports 111 or 113 is at the end of the waveguide 201 extending from the input port 111, whereas the output ports 121 and 123 that receive each 25% of the optical power are at the end of the waveguides 202 and 203 extending from the input ports 112 and 113, respectively.

Preferably, the structure of the three-way directional coupler 102 is just equal and symmetric to the structure of the coupler 101. The optical fields at the output ports 151, 152 and 153 of the second coupler 102 are related to the optical fields at the input ports 141, 142 and 143 thereof by eq. (1). In case the structure of FIG. 2A is adopted, the rephasing region 106 has to be introduced before the coupling region 104 (and not after as in the first coupler 101), so that the three optical fields enter the coupling region with the correct relative phases.

It is observed that it is not strictly necessary to introduce two rephasing regions 106, one in each of the first and the second couplers 101 and 102; a single rephasing region (i.e., a single, widened or narrowed waveguide portion) introduced after the (coupling region of the) coupler 101 or before the (coupling region of the) coupler 102, may be properly designed to compensate for the optical path difference of both the two couplers. The rephasing region 106 can be even eliminated, provided that the required π/2 phase difference between the optical field in the central waveguide and the two external waveguides is obtained somehow else in the coupler 101, 102 or in device 100. For instance, the rephasing can be obtained if the optical length of the external, bent waveguides is optimized with respect to the central waveguide.

It is also observed that if no widened (or narrowed) waveguide portion 161 is provided in the central waveguide 202 in correspondence of the coupling region 104, the output fields of each coupler 101, 102 are related to the input fields by a different expression than eq.(1). However, in practical cases of weakly coupled waveguides, such deviation can be so small that affects the performance of the device is scarcely affected, and the tapering can be dispensed for.

Referring back to FIG. 1A, in an embodiment of the present invention, the three optical devices 131, 132 and 133, which constitute the three arms of the Mach Zehnder interferometer 100, are three generic phase shifters, introducing respective phase shifts φ₁, φ₂ and φ₃. If an input power Jo is supplied to the device 100 through the input port 111, the intensities of the optical fields at the output ports 151, 152 and 153 of the device 100 are respectively given by the expressions (hereinafter referred to as eq.(2)):

$${I}_{1} = {I}_{0} {\vert \frac{1}{4} {e}^{{jφ}_{1}} - \frac{1}{2} {e}^{{jφ}_{2}} + \frac{1}{4} {e}^{{jφ}_{3}} \vert}^{2} , \\ {I}_{2} = {I}_{0} {\vert \frac{j}{2 \sqrt{2}} {e}^{{jφ}_{2}} - \frac{j}{2 \sqrt{2}} {e}^{{jφ}_{3}} \vert}^{2} , \\ {I}_{3} = {I}_{0} {\vert - \frac{1}{4} {e}^{{jφ}_{1}} - \frac{1}{2} {e}^{{jφ}_{2}} - \frac{1}{4} {e}^{{jφ}_{3}} \vert}^{2} ,$$

where I₁, I₂, I₃ is the optical intensity at the output port 151, 152, 153, respectively. The distribution of optical power at the three output ports 151,152 and 153 of the device 100 strongly depends on the phase shifts φ₁, φ₂ and φ₃ introduced by the phase shifters 131, 132 and 133; by properly selecting the phase shifters 131, 132 and 133, the device 100 may thus be advantageously used in a variety of different applications.

In the following, some exemplary optical devices according to different embodiments of the present invention will be presented, all based on the general device structure of FIG. 1A, differing from each other for the type of phase shifters used.

In the invention embodiment schematically shown in FIG. 3, the phase shifters 131, 132 and 133 consist of three optical waveguide sections 231, 232 and 233 having different optical length. In particular, the waveguide sections 231, 232 and 233 have geometrical length L₁, L₂ and L₃, respectively. The phase shift φ₁ induced by the generic waveguide section 23i^{-th} (with i=1, 2, 3) of length L₁ is given by φ₁=2πn₁L₁/λ, where nᵢ is the effective refractive index of the i^{-th} waveguide and λ is the wavelength of the propagating field. The geometrical length L₁ and the effective index nᵢ of each waveguide section are chosen so that the phase shifts on the three interferometer arms 171, 172 and 173 satisfy the condition φ₂=(φ₁+φ₃)/2+2λπ, being in general n₁I₁≠n₃L₃. By substituting such condition into eq.(2) above, the intensities of the optical fields at the output ports 151, 152 and 153 of the device 100 are given by the expressions (hereinafter shortly referred to as eq.(3)):

$${I}_{1} = {I}_{0} {\vert - \frac{1}{2} + \frac{1}{2} cos ( Δφ ) \vert}^{2} = {I}_{0} {sin}^{4} ( \frac{Δφ}{2} )$$

$${I}_{2} = \frac{{I}_{0}}{2} {sin}^{2} ( Δφ )$$

$${I}_{3} = {I}_{0} {\vert - \frac{1}{2} - \frac{1}{2} cos ( Δφ ) \vert}^{2} = {I}_{0} {cos}^{4} ( \frac{Δφ}{2} )$$

being Δφ=φ₁−φ₂=φ₂−φ₃.

The device 100 of FIG. 3 is adapted to be used as an optical interleaver, and can thus be exploited as a building block of a variety of more complex devices, such as optical multiplexers, demultiplexers, filters and so on. As schematically depicted in FIG. 4A, an optical interleaver is a device that ideally splits a Wavelength Division Multiplexed (shortly, WDM) input optical signal 412, received at an interleaver input port 402 and comprising a set of optical channels at wavelengths (λ₁, λ₂, λ₃, λ₄, . . . ), multiplexed at a frequency distance Δƒ from each other, into N output optical signals, each one comprising a subset of the input optical channels, multiplexed at a frequency distance NΔƒ from each other. In the shown example, two output WDM signals 413 and 414, made available at respective interleaver output ports 403 and 404, respectively contain the odd wavelengths (λ₁, λ₃, . . . ) and the even wavelengths (λ₂, λ₄, . . . ) of the original signal 412. As depicted in FIG. 4B, the separation between two adjacent channels in the signals 413 and 414 is twice the channel separation Δƒ in the signal 412. By cascading two or more optical interleavers, the channel spacing can be further increased, so as to ease any subsequent filtering and adding/dropping operation.

An optical interleaver operates correctly when no distortion is introduced in the optical signals. Therefore, the interleaver spectral response should have a wide and fiat (ideally squared) pass-band, particularly wide enough to entirely contain the spectrum of the incoming WDM signals, even when signals are slightly drifted from their nominal central frequencies. The phase response versus frequency of the interleaver should be as linear as possible, to reduce chromatic dispersion effects on the optical signals. Finally, the stop band should be large and as deep as possible, so as to minimize the cross-talk between a transmitted channel and its adjacent stopped channels. The device 100 of FIG. 3 exhibits these features.

FIG. 5A shows in diagrammatic form the dependence on the frequency of the intensity transfer function (i.e., the transmittivity, expressed in dB) of the device of FIG. 3, when the input optical power I₀ is received at the input port 111. In the diagram, the solid line represents the intensity transfer function I₀ between the input port 111 and the output port 151, the dashed line represents the intensity transfer function h between the input port 111 and the output port 153 and the dotted line I₂ represents the intensity transfer function between the input port 111 and the output port 152. When the phase shift Δφ is equal to an odd multiple of π, the input optical signal is entirely transferred to the output port 151, whereas when the phase shift Δφ is equal to an even multiple of π, the input optical signal is entirely transferred to the output port 153. The periodicity of the intensity transfer function is generally referred to as the Free Spectral Range (shortly, FSR). It can be appreciated that the intensity transfer functions I₁ and I₃ have a same FSR, which can be expressed as FSR=c₀/(n_{g1}L₁-n_{g2}L₂)=c₀/(n_{g2}L₂-n_{g3}L₃), being c₀ the light speed in vacuum and the group effective index of the i^{-th} waveguide. According to eq.(3), the FSR of the transfer function I₂ is half the FSR of I₁ and I₃. If the input power is received at the input port 113, the transfer functions I₁ and I₃ are both translated of FSR/2, hence are mutually exchanged. For the sake of simplicity, in the following it is assumed that the three waveguide sections 231, 232, 233 have the same effective refractive index n, although this is not to be construed as a limitation to the present invention. Those skilled in art will appreciate that perturbations of the group refractive index n_{g1} in bent waveguide sections can be easily taken into account

In FIG. 5B a comparison between the spectral response I₁ of the device 100 of FIG. 3 and the spectral response I₁′ of a similar device, based however on a classical, two-arm MZI is shown in diagrammatic form. It can be appreciated that in the conventional device, based on a two-arm MZI, the coupling ratio of the two directional couplers has to be set to 0.5. The phase response versus frequency (not reported in the figure) is linear in both the devices, so that no chromatic dispersion is introduced in signal transmission. The pass-band of the device 100 of FIG. 3 is slightly narrower than that of the conventional, two-arm MZI interleaver. In particular, the bandwidth at 0.1 dB power attenuation is approximately B_{0.1 dB}=0.07 FSR for I₁ and B_{0.1 dB}=0.1 FSR for I₁′, and the bandwidth at 3 dB power attenuation is approximately B_{3 dB}=0.36 FSR for I₁ and B_{3 dB}=0.5 FSR for I₁′. This means that the two-arm MZI interleaver introduces a little less amplitude distortion on a transmitted signal; however, the width of the notch at 20 dB power attenuation is approximately N_{20 dB}=0.2 FSR for I₁ and N_{20 dB}=0.06 FSR for I₁′ and the width of the notch at 30 dB power attenuation is approximately N_{30 dB}=0.11 FSR for I₁ and N_{30 dB}=0.02 FSR for I₁′. A deeper and larger notch is a significant advantage in performance, because it allows reducing the cross-talk given by adjacent channels. It is to be noted that the greater cross-talk reduction in the three-arm MZI interleaver 100 of FIG. 3 is due to the fact that a portion of the cross-talk power comes out of the central output waveguide, as shown by I₂ in FIG. 5A.

The transmittivity versus frequency diagrams reported in FIGS. 6A, 6B and 6C also evidence another advantage of the interleaver based on the device 100 of FIG. 3 over the conventional two-arm MZI interleaver. Let it be assumed that, as a consequence of tolerances in fabrication processes, the directional couplers of both the interferometers (three-arms and two-arms) exhibit a power splitting ratio slightly different from their nominal value. It should be noted that the optical field overlapping in the coupling region of a directional coupler is a critical parameter, which strongly depends on the waveguide geometry, as well as on the core-cladding index contrast Therefore, each optical device containing directional couplers should be as less sensitive as possible to splitting ratio tolerances. The splitting ratio of a generic coupler may be expressed as a function of cL_{c}, where c is a coefficient that includes the optical field overlapping and L_{c} is the effective length of the coupling region. Hereinbelow, the impact of a variation of the parameter cL_{c} of the three-arm interleaver with the impact of a variation of the parameter c′L′_{c} of the two-arm interleaver will be compared.

FIG. 6A shows in the left-hand diagram the variation in the transmittivity I₁ between the input port 111 and the output port 151 of the device 100 in FIG. 3, when a variation of 0%, 10%, 20% an 30% in the parameter cL_{c} in both the three-way directional coupler 101 and 102 is considered. The right-hand diagram in FIG. 6A shows instead the variation in the transmittivity I₁′ of the two-arm MZI interleaver when a similar variation of 0%, 10%, 20% an 30% in the parameter c′L_{c}′ in both the two-way directional couplers is considered. In the case of the three-arm interleaver, an extinction ratio higher than 30 dB is maintained even for a 10% variation in the parameter cL_{c}, and an extinction ratio of 20 dB is maintained for a 20% variation of the parameter cL_{c}. On the contrary, in the two-arm interleaver the extinction ratio is less than 16 dB for a 10% variation of the parameter c′L_{c}′, and the extinction ratio is less than 10 dB for a 20% c′L_{c}′ variation. As visible in FIG. 6B, the greater cross-talk reduction in the three-arm interleaver is achieved thanks to the fact that, as mentioned in the foregoing, when tolerances increases, the output power I₂ from the central port 152 increases as well, so that the vast majority of the cross-talk power leaves through the central waveguide. The diagrams in FIG. 6C show that, as a side effect, compared to the two-arm interleaver a slightly higher power loss in the pass band occurs at the output port 153 of the three-arm interleaver: assuming a variation of 20% in the parameter cL_{c}, the power loss at the maximum of I₃ is 0.9 dB, whereas for a 20% variation in the corresponding parameter c′L_{c}′ the power loss at the maximum of I₃′ is 0.5 dB.

FIG. 7 schematically shows a device 100 according to an alternative embodiment of the present invention, also adapted to be used as an interleaver. In this embodiment, the phase shifters 131, 132 and 133 consist of two optical waveguide sections 331 and 333 (forming the external arms 171 and 173 of the three-arm MZI) and a third waveguide section 332 (the central MZI arm 172) coupled to an optical microring resonator 334. In particular, the microring resonator 334 is coupled to the waveguide section 332 by means of a two-way directional coupler, shown only schematically in the drawing and designated therein as 337. According to eq.(1), the power splitting ratio of both the three-way directional couplers 101 and 102 is 25:50:25 when the optical power is supplied to the coupler through one of the input ports 111, 113 and 141, 143. Preferably, the central arm 172 of the three-arm MZI additionally includes a wavelength-independent phase shifter 336, whose role will be discussed in the following.

Let L₁ L₂ and L₃ be the geometrical length of waveguide sections 331, 332 and 333, and Lᵣ the geometrical length of the optical microring 334. The phase shift φ₂ induced in the central arm 172 of the device 100 is given by the following expression (hereinafter referred to as eq.(4)):

$${φ}_{2} = \frac{2 π}{λ} {nL}_{2} + {tan}^{- 1} ( \frac{( {ρ}^{2} - 1 ) sin {φ}_{r}}{2 ρ - ( 1 + {ρ}^{2} ) cos {φ}_{r}} ) + θ$$

where ρ is the through-path amplitude transmission of the two-way coupler 337, φᵣ=2πnLᵣ/λ is the single-pass phase shift inside the ring and θ is the phase shift introduced by the phase shifter 336. The portion of the power coupled inside the optical ring 334 is given by the power coupling ratio kᵣ=1−ρ².

The microring resonator 334 resonates at all the wavelengths that satisfy the condition 2πnLᵣ/λ=2πm, where m is an integer. In a first-order approximation, the phase shift induced by the optical ring in the neighborhood of each anti-resonance frequency, occurring at 2πnLᵣ/λ=(2m+1)π, is given by the expression (eq.(5)):

$${φ}_{2} = \frac{1 - ρ}{1 + ρ} \frac{2 π}{λ} {nL}_{r} .$$

Advantageously, the optical waveguide sections 331 and 333 have substantially equal length (L₁=L₃=L) and hence a substantially equal phase shift φ₃=φ₁=2πnL₁/λ is induced in the external arms 171 and 173 of the interferometer. Indicating as ΔL be the difference between the length L of the external arms 171, 173 and the length L₂ of the central arm 172 of the interferometer, a symmetrical and periodical frequency response with a flat squared pass-band and a deep and wide notch in the rejection band is obtained when the length Lᵣ of the optical microring is set to Lᵣ=2ΔL and the value of φ₂ at the anti-resonance equals the value of φ₁, that is (eq.(6)):

$$\frac{1 - ρ}{1 + ρ} {L}_{r} = Δ L$$

Such a condition is achieved for ρ=⅓, which corresponds to kᵣ=0.89.

The phase shifter 336 is preferably included in the central arm of the interferometer for making the three optical waves propagating in the three arms 171, 172, 173 of the device combine at the second coupler 102 with the correct relative phase. In particular, a wavelength-independent phase shift of π/2 (or, equivalently, of −π/2) has to be introduced in the central arm. In one embodiment of the present invention, the phase shifter 336 consists of a straight waveguide section of length λ₀/4n, where λ₀ is the central wavelength of the wavelength range of interest. Despite the phase shift thus introduced is not perfectly wavelength-independent for any wavelength, it may work in a large range of wavelengths.

FIG. 8A shows in diagrammatic form the transmittivity, in dB, of the device 100 of FIG. 7, when the input optical power is received at the input port 111. The solid line represents the intensity transfer function I₁ between the input port 111 and the output port 151, and the dashed line represents the intensity transfer function I₃ between the input port 111 and the output port 153. The output optical power I₃ at the central port 152 is zero at any wavelength. The transfer function I₃ is an exact replica of the transfer function I₁, shifted of a free spectral range FSR=c₀/nΔL. As in the case of the device 100 of FIG. 3, if the input optical power is received at the input port 113, I₁ and I₃ are translated of FSR/2 and exchange their spectral position.

The diagram in FIG. 8B shows a comparison between the spectral response I₁ of the device 100 of FIG. 7 and the spectral response I₁′ of the device 100 described in the foregoing in connection with FIG. 3. It can be appreciated that the presence of the microring resonator 334 causes the transfer function I₁ to be flattened inside the pass-band, and widens the notch in the stop-band. This means that, compared to the device 100 of FIG. 3, the device 100 of FIG. 7, when used as an interleaver, both introduces less amplitude distortion on a transmitted signal and reduces cross-talk given by adjacent stopped channels. In particular, the bandwidth at 0.1 dB power attenuation is approximately B_{0.1 dB}=0.3 FSR for I₁ (B_{0.1 dB}=0.07 FSR for I₁′) and the bandwidth at 3 dB power attenuation is approximately B_{3 dB}=0.49 FSR for I₁ (B_{3 dB}=0.36 FSR for I₁′). The width of the notch at 20 dB power attenuation is approximately N_{20 dB}=0.27 FSR for I₁ and (N_{20 dB}=0.2 FSR for I₁′) and the width of the notch at 30 dB power attenuation is approximately N_{30 dB}=0.20 FSR for I₁ and (N_{30 dB}=0.11 FSR for I₁′). It is observed that a greater cross-talk reduction in the device of FIG. 7 is achieved even though no cross-talk power leaves through the central output waveguide.

The Applicant observes that since in the device of FIG. 7 an equal phase shift φ₃=φ₁ is induced in the external arms 171, 173 of the interferometer, a similar transfer function can in principle be obtained by using a classical, two-arm interferometer. A suitable two-arm interferometer equivalent to the three-arm interferometer of FIG. 7 has the first arm identical to the central arm of the device of FIG. 7 and the second arm identical to any of two external arms of the three-arm interferometer. The unbalance between the two arms is again set to ΔL and the power splitting ratio of the directional coupler is 0.5.

However, the actual performance of the devices would be different, as demonstrated by the following comparison of the impact of a variation of the parameter cL_{c} of the three-arm MZI interleaver with the impact of a variation of the parameter c′L′_{c} of the two-arm MZI interleaver. FIG. 9A shows in left-hand diagram the variation in the transmittivity (in dB) I₁ between the input port 111 and the output port 151 of the device of FIG. 7, when a variation of 0%, 10%, 20% an 30% in the parameter cL_{c} is considered in both the three-way directional couplers 101 and 102. The right-hand plot in FIG. 9A shows the variation in transmittivity I₁′ of the microring-based two-arm MZI interleaver when a similar variation of 0%, 10%, 20% an 30% in the parameter c′L_{c}′ is considered in both its directional couplers. Similarly to what already described in connection with the device of FIG. 3, in the three-arm MZI interleaver an extinction ratio higher than 30 dB is maintained even for a 10% cL_{c} variation, and an extinction ratio of 20 dB is maintained for a 20% cL_{c} variation. Differently, in the two-arm ring-based MZI interleaver the extinction ratio is less than 16 dB for a 10% c′L_{c}′ variation, and less than 10 dB for a 20% c′L_{c}′ variation. As in the case of the device of FIG. 3, the greater cross-talk reduction in the three-arm MZI interleaver is achieved thanks to the fact that, when the tolerances increases, the output power I₂ from the central port 152 increases as well, so that the vast majority of the cross-talk power leaves through the central waveguide (as depicted in FIG. 9B). Again, the diagrams in FIG. 9C show that a slightly greater power loss inside the pass band occurs at the output port 153 of the ring based three-arm interferometer with respect to the ring based two-arm interferometer assuming a variation of 20% in the parameters cL_{c} and c′L_{c}′, the power loss at the maximum of I₃ is 0.9 dB, whereas the power loss at the maximum of I₃′ is 0.5 dB again.

FIG. 10 schematically shows a three-arm MZI optical device 100 according to another embodiment of the present invention. In the device of FIG. 10, the phase shifters 131, 132, 133 consist of a first optical waveguide section 431 coupled to a first optical microring resonator 434 by means of a first two-arm directional coupler 438, a second optical waveguide section 432 coupled to a second optical microring resonator 435 by means of a second two-arm directional coupler 439, and a third optical waveguide section 433 coupled to a third optical microring resonator 436 by means of a third two-arm directional coupler 440. According to eq.(1), the power splitting ratio of both the three-arm directional couplers 101 and 102 is 25:50:25 when the optical power is received by the coupler through one of the external ports 111, 113 and 141, 143 thereof.

Preferably, the three microring resonators 434, 435 and 436 have substantially a same geometrical length Lᵣ, hence all the resonators 434, 435 and 436 resonate substantially at same resonant frequencies. Let ρ₂ be the through-path amplitude transmission of the two-arm directional coupler 439; the through-path amplitude transmissions ρ₁ and ρ₃ of the two-arm directional couplers 438 and 440 are preferably equal to each other (ρ₁=ρ₃=ρ). The fraction of the optical power coupled inside each of the rings 434 and 436 is given by the power coupling ratio kᵣ=1−ρ². Let L₁ be the geometrical length of the waveguide section 431, L₂ the geometrical length of waveguide section 432 and L₃ the geometrical length of waveguide section 433. The optical waveguide sections 431 and 433 have preferably substantially equal length (L₁=L₃=L) so that a substantially equal phase shift φ₃=φ₁=φ is induced in the external arms 171, 173 of the three-arm MZI. The phase shift induced in the central arm 172 of the MZI is φ₂. Similarly to the embodiment of FIG. 7, the central arm 172 of the MZI also includes a wavelength-independent phase shifter 437, having the function of adjusting the relative phase of the three optical waves propagating in the three arms 171, 172, 173 of the device.

Advantageously, the length Lᵣ of the microrings 434, 435, 436 is equal to Lᵣ=2ΔL, being ΔL the difference between the length L of the external arms 171, 173 and the length L₂ of the central arm 172 of the MZI. A symmetrical and periodical frequency response with a flat squared pass-band and a deep and wide notch in the rejection band is obtained when the value of the phase shift φ₂ at the anti-resonance equals the value of the phase shift φ at the anti-resonance, that is (eq. (7)):

$$\frac{1 - {ρ}_{2}}{1 + {ρ}_{2}} {L}_{r} = \frac{1 - ρ}{1 + ρ} {L}_{r} + Δ L .$$

Such a condition leads to the relation (eq. (8)):

$${ρ}_{2} = \frac{3 ρ - 1}{ρ + 5} .$$

Generally, the higher the values of ρ and ρ₂, the more the spectral response of the device becomes box-like, with very sharp transition region. However, when p and pi are increased too much, a detrimental ripple inside the pass band appears and the magnitude of the sidelobes increases.

FIG. 11A shows a diagram of the transmittivity (in dB) of the device of FIG. 10, when the input power is received at the input port 111. The solid line represents the intensity transfer function I₁ between the input port 111 and the output port 151, while the dashed line represents the intensity transfer function h between the input port 111 and the output port 153. It is observed that the output power h at the central port 152 is zero at any wavelength. It can be appreciated that the transfer function h is an exact replica of the transfer function I₁, shifted of a free spectral range FSR=c₀/nΔL. As in the case of the device in FIG. 3, if the input power is received at the input port 113 instead that at the input port 111, the transfer functions I₁ and I₃ are translated of FSR/2 and exchange their spectral position. The couplers 438 and 440 have an amplitude transmission ρ=0.67 (corresponding to kᵣ=0.55), the coupler 439 has an amplitude transmission ρ₂=0.18 (corresponding to kᵣ₂=0.97), so that the sidelobes magnitude is at least 30 dB lower than the spectral response maximum and the ripple in the pass band is lower than 0.005 dB.

FIG. 11B shows a comparison between the spectral response I₁ of the three-arm MZI interleaver of FIG. 10 and the spectral response I₁′ of the three-arm interleaver described in the foregoing in connection with FIG. 7. It can be appreciated that the provision of a microring resonator 434, 435, 436 in every arm 171, 172, 173 of the MZI causes a further flattening of the transfer function inside the pass-band, and widens the notch in the stop-band. In particular, the bandwidth at 0.1 dB power attenuation is approximately B_{0.1 dB}=0.43 FSR for I₁ (B_{0.1 dB}=0.3 FSR for I₁′), and the bandwidth at 3 dB power attenuation is approximately B_{3 dB}=0.5 FSR for I₁ (B_{3 dB}=0.49 FSR for I₁ ′). The width of the notch at 20 dB power attenuation is approximately N_{20 dB}=0.43 FSR for Iᵢ (N_{20 dB}=0.27 FSR for I₁′) and the width of the notch at 30 dB power attenuation is approximately N_{30 dB}=0.4 FSR for I₁ and (N_{30 dB}=0.20 FSR for I₁′).

The Applicant observes that since in the device of FIG. 10 an equal phase shift φ₃=φ₁ is induced in the external arms 171, 173 of the MZI, a similar transfer function might in principle be obtained using a two-arm MZI, having a first arm identical to the central arm 172 of the device of FIG. 10, and a second arm equal to either one of the two external arms 171, 173 of the three-arm MZI of FIG. 10. The unbalance between the two arms is again set to ΔL, and the power splitting ratio of the directional coupler is 0.5.

However, a variation of the parameter cL_{c} of the three-arm MZI of FIG. 10 has a significantly lower impact on the response of the optical device than a variation of the parameter c′L′_{c} of the two-arm MZI. FIG. 12A shows in the left-hand diagram the variation of the transmittivity h between the input port 111 and the output port 151 of the device of FIG. 10, when a variation of 0%, 10%, 20% an 30% in the parameter cL_{c} is considered in both the directional couplers 101 and 102. The right-hand diagram in FIG. 12A shows instead the variation of the transmittivity I₁′ of the ring-based two-arm MZI, when a similar variation of 0%, 10%, 20% an 30% in the corresponding parameter c′L_{c}′ is considered in both the directional couplers thereof. Similarly to what happens in device of FIG. 3, in the three-arm MZI of FIG. 10 an extinction ratio higher than 30 dB is maintained even for a 10% cL_{c} variation (except at the peak power of the sidelobes) and an extinction ratio of 20 dB is maintained for a 20% cL_{c} variation. Differently, in the two-arm ring-based MZI the extinction ratio is less than 16 dB for a variation of 10% in the parameter c′L_{c}′, and is less than 10 dB for a 20% variation in c′L_{c}′. As in the case of the device of FIG. 3, the greater cross-talk reduction in the three-arm MZI is achieved thanks to the fact that, when tolerances increases, the output power h from the central port 152 increases as well, so that the vast majority of the cross-talk power leaves through the central waveguide (FIG. 12B). As shown in FIG. 12C, a slightly greater power loss inside, the band pass occurs at the output port 153 of the ring based three-arm interferometer with respect to the ring based two-arm interferometer: assuming a variation of 20%, the power loss at the maximum of I₃ is 0.9 dB and the power loss at the maximum of I₃′ is 0.5 dB again.

It is pointed out that the invention embodiments described in connection with FIG. 7 and FIG. 10 are merely intended to provide two examples of ring-based three-arm MZIs that can be realized using the device 100 according to the present invention; more complex configurations can be devised so as to further improve the spectral response of the device. More generally, each one of the three arms 171, 172, 173 of the MZI can be designed as schematically shown in FIG. 13A or in FIG. 13B, wherein a generic one 171 of the three arms 171, 172, 173 of the MZI is depicted as coupled to a plurality of π microring resonators 450-1, 450-2, 450-3, . . . , 450-n. The geometrical length L₁ of a straight waveguide section connecting one of the three output ports 121, 122, 123 of the first three-arm coupler 101 to a corresponding one of the input ports 141, 142, 143 of the second three-arm coupler 102, is generally different for each arm of the device. More than one microring optical resonator 450-1, 450-2, 450-3, . . . , 450-n can be introduced in each arm 171, 172, 173 of the MZI, both in a parallel configuration (FIG. 13A) and in a series configuration (FIG. 13B). The length in and the coupling ratio pt of the generic microring 450-1, 450-2, 450-3, . . . , 450-n should be properly chosen so as to achieve the desired phase shift in each arm. Furthermore, a wavelength-independent phase shifter 451 (introducing a phase shift θ) can be introduced in each arm 171, 172, 173 to adjust the relative phase of the three optical waves propagating in the three arms of the device.

FIG. 14 schematically shows an optical device 100 according to another embodiment of the present invention, in which the phase shifters 131, 132, 133 respectively consist of a first optical waveguide section 531 comprising a first Bragg grating 534, a second optical waveguide section 532 comprising a second Bragg grating 535 and a third optical waveguide section 533 comprising a third Bragg grating 536. Preferably, the power splitting ratio of both the three-way directional couplers 101 and 102 is 25:50:25 when the power is fed to the coupler at one of the external input ports 111, 113 and 141, 143 thereof, according to eq.(1).

In a way known in the art, a Bragg grating can be realized by periodically etching an integrated optical waveguide spatial profile, in order to create a lateral corrugation or an upper corrugation of the optical waveguide. The periodical change in the waveguide geometry leads to a periodic longitudinal modulation of the waveguide effective refractive index n. Alternatively, a direct periodical modulation of the waveguide effective refractive index n can be induced by exposing a photosensitive medium to a pattern of diffracted UV light. In this case, the periodical variation of the effective refractive index n causes, a forward and backward waveguide mode coupling, so that the Bragg grating acts as a wavelength-dependent mirror. In particular, if the period of the Bragg grating is Λ, the grating reflects all the wavelengths contained inside a reflection band that is centered at a so-called Bragg wavelength λ_{B}, defined as λ_{B}=2nΛ. The reflection bandwidth is approximately Δλ=(δn/n)λ_{B}, where δn is the effective index modulation depth. Preferably, the three Bragg gratings 534, 535, 536 have substantially the same index modulation depth δn, the same period Λ and the same number of periods.

One skilled in the art may recognize that the three-arm MZI of FIG. 14 is adapted to act as an optical add-drop multiplexer, i.e., an optical device capable of extracting at least one channel λ₁ from an incoming WDM signal comprising a set of optical channels, and inserts a new channel λ₁ in the WDM signal.

FIG. 15A schematically shows the behavior of the device of FIG. 14, supposed to receive at the input port 111 an input WDM signal 612 comprising channels at wavelengths (λ₁, λ₂, λ₃, λ₄, . . . ). Let it be assumed that the wavelength λ₃ coincides with the Bragg wavelength λ_{B} of the three Bragg gratings 534, 535, 536. Therefore, the power of the channel λ₃ propagating in each arm 171, 172, 173 is backward-reflected towards the first coupler 101, which acts as a combiner. If the reflectivity of the Bragg grating is sufficiently high, no power at the wavelength λ₃ arrives at the second coupler 102, and the channel λ₃ entirely leaves the device 100 through the port 113 (acting in this case as an output port) of the first coupler 101. All the other wavelengths λ₁ (i≠3) of the input signal 612 falling outside the reflection band of the Bragg gratings 534, 535, 536 are not backward-reflected. The signal leaving through the output port 153 of the device 100 thus contains all the channels of the input signal 612 with tile exception of the channel λ₃ (the so-called dropped channel).

In a similar way, FIG. 15B depicts the behavior of the device of FIG. 14, when an input WDM signal 615 comprising channels at wavelengths (λ₁, λ₂, λ₄, . . . ) is supplied at the input port 111 and the channel λ₃ is supplied at the port 151 (acting in this case as an input port). Since λ₃ is the only wavelength to be reflected by the Bragg gratings, the signal 617 leaving the device 100 through the output port 153 contains all the channels of the input signal 612, with the addition of the channel λ₃ (the added channel).

The add-drop operation should be transparent to all the wavelengths different from λᵢ. FIG. 15C is a schematic sketch of the spectral response of an ideal add-drop multiplexer. The drawing on the left represents the ideal power transfer function between the input port 111 and the output port 113, that should coincide with the ideal power transfer function between the input port 151 and the output port 153. The drawing on the right represents the ideal power transfer function between the input port 111 and the output port 153, that should coincide with the ideal power transfer function between the input port 151 and the output port 113. As mentioned in the foregoing in relation to an optical interleaver, an optical add-drop multiplexer should not introduce any distortion in the optical signals. As depicted in FIG. 15C, the spectral response of an add-drop multiplexer should be as flat as possible in the pass-band and in the stopped band. The reflection band of the gratings should be wide enough to entirely contain the spectrum of the channel to be reflected, but should not affect the adjacent channels. Such properties only depend on the Bragg grating spectrum, which should be optimized to be as box-like as possible.

Two or more Bragg gratings having different Bragg wavelength λ_{B} can be cascaded in each arm 171, 172, 173 of the device 100, so as to make the device capable of adding/dropping more than one channel at the same time. However, in order to avoid undesired cavity effects, the spectra of the cascaded Bragg gratings should never overlap.

The optical add-drop multiplexer according to this embodiment of the present invention has improved performance compared to an optical add-drop multiplexer realized by introducing a Bragg grating in both the two arms of a classical two-arm MZI. When the power slitting ratios of the two optical couplers of a two-arm MZI departs from their nominal, 50:50 value, the add-drop performance is strongly affected, due to cross-talks. Optical isolators need to be introduced at the input ports, but these devices are cumbersome and expensive.

On the contrary, similarly to the above-discussed optical interleaver according to an embodiment of the present invention, the three-arm Mach-Zehnder add-drop of FIG. 14 is less sensitive to fabrication tolerances with respect to the conventional add-drop based on a two-arm MZI. If the power splitting ratio of the two three-way couplers 101, 102 departs from the ideal 25:50:25 ratio, some of the power of, e.g., the channel λ₃ comes out of the ports 111 and 112. The portion of the optical power leaving the device through the port 111 coincides with the cross-talk power leaving through the port 151 of a three-arm interleaver having the same power splitting ratio tolerances (FIG. 6B, for example). If the variation in the coefficient cL_{c} is lower than 20% compared to the nominal value, the portion of the optical power leaving through the port 111 is 20 dB under the power level of the input signal and the use of optical isolators can be avoided. On the contrary, in the conventional add-drop based on a two-arm MZI a 20% variation in the cL_{c} coefficient of the two-way couplers implies that the portion of the power leaving through the port 115 is only 10 dB under the power level of the input signal and the optical isolator is required.

FIG. 16 schematically shows an optical device 100 according to another embodiment of the present invention, in which the phase shifters 131, 132, 133 consist of three substantially straight optical waveguide sections 631, 632 and 633 having a substantially equal optical length L. Over these three optical waveguide sections, a DC electrode structure is arranged, comprising three metal electrodes 634, 635 and 636. As better visible in the cross-sectional view of FIG. 17, each electrode 634, 635 and 636 preferably lies just over or nearby a respective one of the three optical waveguide sections 631, 632 and 633. When no current is supplied into the electrodes 634, 635 and 636, the three arms 171, 172, 173 of the MZI are perfectly balanced and all the optical power at the input port 111 is transferred at the output port 153, whichever the wavelength of the input optical field. When the electrodes 634, 635 and 636 are connected to a respective voltage (or a current) supply V₁, V₂, V₃, as schematically shown in top view in FIG. 18, the current I₁, I₂, I₃ that flows through each electrode induces a temperature rise of the electrode itself, which acts as a Joule-effect heater; the temperature around each heater depends on the dissipated power, and is related to the geometry of the electrodes, the resistivity of the heater material and the current flow. A variable phase shift of the optical fields propagating in the three arms of the Mach-Zehnder can thus be obtained by means of the thermo-optic effect. The temperature change induces a change in the refractive index of the waveguide material, and hence in the effective refractive index seen by the propagating optical mode. The dependence of the refractive index on the temperature is expressed by the coefficient α=dn/dT, that in silica-based waveguide is typically α=1.2·10⁻³ K⁻¹. Let φ₁, φ₂ and φ₃ be respectively the thermally-induced phase shifts in the waveguides 631,632 and 633, respectively. If the conditions φ₂-φ₁=π and φ₃-φ₂=π are satisfied, that is (eq. (9)):

$$Δ {T}_{2} - Δ {T}_{1} = Δ {T}_{3} - Δ {T}_{2} = \frac{λ}{2 α L} ,$$

all the power at the input port 111 is thermally switched at the output port 151. A thermo-optic switch has thus been obtained. It is pointed out that the longer the length L, the smallest is the required temperature difference. For instance, if L=3 cm, only a 2K temperature change is needed to switch the output field from the output port 151 to the output port 153.

The thermo-optic switch 100 according to this embodiment of the present invention has improved performance compared to a similar thermo-optic switch realized by arranging two metal electrodes on the two arms of a classical, two-arm MZI. As in the case of the optical interleaver of FIG. 3, in case of unbalance, the notch of the device 100 of FIG. 16 is substantially larger than that of the two-arm MZI counterpart. This implies that when the device 100 is used as a switch, there is a lower sensitivity to phase shift tolerances, and either one of the output ports 151, 153 are more easily switched off. Moreover, as shown in FIGS. 6A, 6B and 6C, the notch of the three-arm interferometer is less sensitive to power splitting ratio tolerances of the directional couplers 101, 102.

It is worth noting that the device 100 of FIG. 16 can also be used as a thermo-optic Variable Optical Attenuator (a VOA), when only one of the output ports 151 or 153 is used: the power level at the output port can be conveniently reduced by thermally adjusting the phase shift of the optical fields m the arms 171, 172, 173 of the MZI, while the undesired power is wasted at the other two ports of the Mach-Zehnder.

FIG. 19 schematically shows an optical device 100 according to still another embodiment of the present invention, in which, similarly to the embodiment of FIG. 17, the phase shifters 131, 132, 133 consist of three straight optical waveguide sections 631, 632 and 633 having substantially equal optical length L, over which a DC electrode structure is arranged. In this embodiment, differently from the embodiment of FIG. 16, the DC electrode structure comprises a central ground electrode 638 arranged over the central waveguide section 632, and two external electrodes 637 and 639, arranged laterally to the waveguide sections 631 and 633 from the side thereof opposite to that adjacent the central waveguide section 632. The two external electrodes 637 and 639 are used for applying a DC voltage to the three-arm MZI. A variable phase shift of the optical fields propagating in the three arms 171, 172, 173 of the MZI can be obtained by the electro-optic effect. When no voltage is applied to the external electrodes 637 and 639, the three arms 171, 172, 173 of the MZI are perfectly balanced and all the power received the input port 111 is transferred to the output port 153, whichever the wavelength of the input field. If a voltage is applied between one of the external electrodes 637 and 639 and the central electrode 638, the DC electric field overlapping the corresponding optical waveguide section 631 or 633 induces a variation of the refractive index thereof. FIG. 20 schematically shows the cross-section of the three arms of the device along the line XX-XX, and FIG. 21 shows the top view of the device in the region of the electrodes. The dependence of the refractive index on the applied electric field is expressed by the electro-optic coefficient of the waveguiding material. Let φ₁, φ₂ and φ₃ be the electrically-induced phase shifts in the waveguide sections 631, 632 and 633, respectively. The switching condition is achieved when φ₂-φ₁=π and φ₃-φ₂=π, that is (eq.(10)):

$${V}_{2} - {V}_{1} = \frac{λ}{2 rL} ,$$

where r is a coefficient that includes the electro-optic coefficient of the material and the overlapping integral between the optical field and the electric field.

The electro-optic switch 100 according to this embodiment of the present invention has improved performance compared to a similar electro-optic switch realized by using of a conventional two-arm MZI, whose arms are variably unbalanced by means of an electrode structure. In particular, the electro-optic switch of FIG. 19 is less sensitive to phase shift tolerances, and the output port may be more easily switched off.

As in the case of the device of FIG. 17, the device of FIG. 19 can be also used as an electro-optic VOA, when only one output port (151 or 153) is used.

In integrated optical devices based on semiconductor materials, the phase modulation of the optical field can also be induced via the charge carrier effect, also known as plasma dispersion effect. Without descending into particulars well known in the art, the plasma dispersion effect relies on the dependence of the refractive index of typical semiconductors, such as silicon, on the concentration of free charge carriers. FIGS. 22 and 23 schematically show, respectively in top view and in cross section along the line XXIII-XXIII a small portion of an integrated optical device 100 according to still another embodiment of the present invention, particularly a portion of a generic arm 171 (i=1, 2, 3) of the three-arm MZI, with an associated phase modulation arrangement exploiting the plasma dispersion effect in a semiconductor optical waveguide section 731. It is pointed out that such an arrangement can be associated with each arm 171, 172, 173 of the three-arm MZI 100. The optical waveguide 731 can be for example realized by implanting oxygen in a silicon substrate to create an SiO₂ insulating layer (SIMOX technology), as visible in FIG. 23, where a rib waveguide is depicted. However, it is pointed out that the specific type of waveguide depicted in FIG. 23 is merely exemplary, and is not to be construed as a limitation to the present invention. On the top of the waveguide 731, a P-doped region 735 and an N-doped region 736 are formed, so that a succession of integrated PN junction diodes is obtained, distributed longitudinally to the waveguide 731. When a driving current of the diodes is varied by varying a voltage Vi applied thereacross, the injected charge distribution varies as well, thus inducing the desired refractive index modulation.

FIG. 24 shows an optical device 100 according to still a further embodiment of the invention. The device 100 comprises three optical waveguide sections 831, 832 and 833 having substantially the same geometrical length L. The two waveguide sections 831 and 833, forming the external arms 171, 173 of the MZI, are made of a nonlinear material. Nonlinear materials of the _{X2} type or the _{X3} type can be used. The waveguide section 832, forming the central arm 172 of the MZI, and the two couplers 101 and 102 need not be made of nonlinear materials, but the use of the same material as in the waveguides 831 and 833 is preferred, from the point of view of making the device fabrication processes easier.

FIGS. 25A and 25B schematically show the behavior of the device shown in FIG. 24, which can be used as an all-optical switch. Let it be supposed that the two waveguide sections 831 and 833 are made of a nonlinear material of the _{X3} type. FIG. 25A depicts the case in which only a small-intensity signal (simply, a small signal) λₛ is supplied at the input port 111 of the device 100. Since the three arms 171, 172, 173 of the MZI have the same optical length, the signal λₛ leaves the device from the output port 153. FIG. 25B depicts the case in which the small signal λₛ is supplied at the input port 111 of the device 100, and at the same time an intense signal λₚ, acting as a pump signal, is supplied at the central input port 112 of the device 100. According to eq.(1), the first coupler 101 splits the pump signal λₚ, so that substantially 0% of the power thereof is transferred to the central arm 172 of the MZI (i.e., no power of the pump signal is coupled into the waveguide section 832), whereas each of the two external arms 171 and 173 (i.e., the waveguide sections 831 and 833) receive half the power of the input pump signal λₚ. The presence of the pump signal in the waveguide sections 831 and 833 induces a nonlinear phase shift φ_{NL} of the signal λₛ by means of Cross-Phase Modulation (XPM), that is given by (eq.(11)):

$${φ}_{NL} = \frac{2 π {P}_{p}}{{λ}_{s} {A}_{eff}} {n}_{2} L ,$$

where Pₚ is the power of the pump signal (the pump power), A_{eff} is the waveguide effective area and n₂ is the well-known nonlinear refractive index. When φ_{NL}=(2M+1)π, the input small signal λₛ is switched from the output port 153 to the output port 151, as shown in FIG. 25B. It is important to underline that, thanks to the symmetry of the device 100, the pump signal always experiences the same phase shift in both the two optical paths 831 and 833. Therefore, whichever the pump power, the pump signal always leaves the device 100 through the central port 152, so that it is never necessary to use additional devices, such as WDM couplers, to separate the signal wave from the pump wave.

The device shown in FIG. 24 can also be used to realize an optical XOR logic gate operating on the basis of XPM. In this case, two intense signals (pump waves) λₚ₁ and λₚ₂ are needed. The pump wave λₚ₁ is supplied at the central input port 112, the pump wave λₚ₁ is counter-propagating and it is supplied at the central input port 152. Let it be supposed that a small signal λₛ having power Pₛ is fed at the input port 111 of the device 100. Each pump wave λₚ₁, λₚ₂ induces a nonlinear phase shift φ_{NL} of the signal λₛ in the external arms 831 and 833 according to eq.(11). When no pump is on (Pₚ₁=0, Pₚ₂=0), the signal λₛ leaves the device 100 from the output port 153. When one of the two pumps is on (Pₚ₁=Pₚ, Pₚ₂=0 or, equivalently, Pₚ₁=0, Pₚ₂=Pₚ, where the pump power Pₚ is chosen in such a way as to satisfy the condition φ_{NL}=(2M+1)π), the input signal λₛ is switched from the output port 153 to the output port 151. When both the two pumps are on (Pₚ₁=Pₚ, Pₚ₂=Pₚ), the two contributions to the nonlinear phase shift add, that is φ_{NL}=2(2M+1)π), and the signal λₛ leaves the device 100 from the output port 153 again. The behavior of the device 100 can be resumed in the following table, that is exactly the truth table of a XOR logic gate at the output port 151, and of a negate XOR logic gate (#XOR) at the output port 153.

| | | XOR | #XOR |
|---|---|---|---|
| Pₚ₁ | Pₚ₂ | (port 151) | (port 153) |
| 0 | 0 | 0 | Pₛ |
| 0 | Pₚ | Pₛ | 0 |
| Pₚ | 0 | P₃ | 0 |
| Pₚ | Pₚ | 0 | Pₛ |

Moreover, the device shown in FIG. 24 can be also used to realize an optical self-switch. Let it be supposed that the three waveguides 831, 832 and 833 are made of a nonlinear material of the _{X3} type. As discussed in connection with FIG. 25A, when a small signal λₛ is supplied at the input port 111 of the device 100, the signal λₛ leaves the device from the output port 153. However, when the intensity of the signal λₛ is increased, a nonlinear phase shift φ_{NL} of the signal λₛ is induced by means of Self-Phase Modulation (SPM) effect Since the first coupler 101 splits the power of the signal wave λₛ in the ratio 25:50:25, the nonlinear phase shift φ_{NL,c} in the central arm 832 is given by (eq. (12)):

$${φ}_{NL , c} = \frac{π {P}_{s}}{{λ}_{s} {A}_{eff}} {n}_{2} L$$

while the nonlinear phase shift φ_{NL,ext} in the two external arms 831 and 833 is (eq. (13)):

$${φ}_{NL , ext} = \frac{1}{2} \frac{π {P}_{s}}{{λ}_{s} {A}_{eff}} {n}_{2} L$$

where Pₛ is the power of the signal λₛ.

When Δφ_{NL}=φ_{NL,c}-φ_{NL,ext}=(2M+1)π, the signal λₛ is switched from the output port 153 to the output port 151.

It is observed mat if the central waveguide 832 is not made of a nonlinear material, the nonlinear phase shift φ_{NL,c} in the central waveguide vanishes (φ_{NL,c}=0), but the input signal λₛ is still switched to the output port 151 when the condition Δφ_{NL}=φ_{NL,ext}=(2M+I)π is satisfied.

FIG. 26 schematically shows an optical device 100 according to another embodiment of the present invention, in which the three arms 171, 172, 173 comprise three substantially straight optical waveguide sections 931, 932 and 933 having substantially a same optical length L, each optical waveguide section 931, 932 and 933 including a respective Semiconductor Optical Amplifier (SOA) 937, 938 and 939.

FIGS. 27A and 27B depicts two possible applications of the device shown in FIG. 26, which can be used as an all-optical wavelength converter based on Cross Phase Modulation (XPM) in SOA. The XPM in SOA relies on the change in the charge carrier density that can be controlled via the bias current of the SOA or the input optical power, since the change in the carrier density implies a change in the refractive index in the active region of SOA. In principle, only the two SOAs 937 and 939 in the external waveguides 931 and 933 are required, but a third SOA 938 in the central waveguide 932 may be conveniently used in order to adjust the power level and increase the gain of the device. A continuous wave CW at a wavelength λ_{c} is injected into one of external input ports 111, 113 of the three-arm MZI 100. FIG. 27A depicts the case in which the CW at wavelength λ_{c} is supplied at the input port 111, but the input port 113 could be used as well, thanks to the symmetry of the device. A modulated signal at a wavelength λ₁ is supplied at the central port 112 of the device 100. According to eq.(1), the first coupler 101 splits the modulated signal λ₁ so that substantially 0% of the power thereof is transferred to the central arm 172 (i.e., the waveguide section 932), and the two external arms 171, 173 (i.e., the waveguide sections 931, 933) receive each approximately 50% of the power of the signal λ₁. When the signal λ₁ depletes the carrier density in the SOA, an intensity-dependent phase modulation is induced in the continuous wave λ_{c} only in the external arms 171, 173 of the MZI, so that an intensity modulation format results at the output of the device 100. Depending on the biasing of the device, a converted wave X_{c} having the same intensity modulation format as the input signal λ₁ is obtained at one of the two external output ports 151 (as in FIG. 27A) or 153. The converted optical wave λ_{c} leaving the device from the other external output port (port 153 in the example shown in FIG. 27A) has just the opposite intensity modulation format as the input signal λ₁. On the contrary, the signal λ₁ always leaves the device through the central port 152, so that it is never necessary to use additional devices, such as WDM couplers, to separate the signal wave from the pump wave.

The device 100 may also be used in a counter-propagating configuration, as shown in FIG. 27B. The intensity-modulated signal λ₁ is in this case supplied at the central port 152 of the device (now acting as input port). According to eq.(1), the second coupler 102 splits the signal λ₁ so that substantially 0% of the power thereof is transferred to the waveguide section 932, while each one of the waveguide sections 931 and 933 receives approximately 50% of the power of the signal λ₁. As in FIG. 27A, the converted wave is obtained at one of the two external output ports 151 or 153 and the signal λ₁ leaves the device from the central port 112.

The all-optical wavelength converter 100 according to this embodiment of the present invention has improved performance compared to an all-optical wavelength converter exploiting XPM in SOA based on a two-arm MZI. In the latter case, γ-branches need to be used for supplying the intensity-modulated signal λ₁ and the inverted signal λ₁ to a first arm and a second arm of the device; this introduces power losses; additionally, an optical isolator is needed for preserving the CW source from the backward wave λᵢ.

The optical device 100 according to the present invention is preferably realized in integrated optics technologies. The optical waveguides can be diffused waveguides, ridge waveguides, rib waveguides or channel waveguides. The three waveguide sections forming the arms 171, 172, 173 of the MZI are preferably, but not necessarily, equal to each other as to material and transversal characteristics.

A variety of preferred materials can be employed in the above-discussed embodiments of the present invention.

For example, in the embodiments of FIG. 22 or FIG. 26, the three optical waveguides in the three arms of the MZI are preferably made of silicon or other suitable semiconductors having a useful transparency at optical frequencies (AlGaAs or other III-V compounds).

In the embodiment described in connection with FIGS. 23 and 24, the three nonlinear optical waveguides 731 (i=1, 2, 3) are preferably made of a material with a high nonlinear coefficient, such as TeO₂, polymers or semiconductors having a useful transparency at optical frequencies (AlGaAs, Si or other III-V compounds).

In the embodiment of FIG. 19, the three optical waveguides 631, 632 and 633 are preferably made of a material with a high electro-optic coefficient. The device may be fabricated in a substrate of lithium niobate, lithium tantalate or related crystal compounds. The lithium niobate or related compound may be x-cut or z-cut The waveguides may be diffused waveguides, created by diffusing titanium in the substrate.

In the embodiment of FIG. 16, the three optical waveguides 631, 632 and 633 are preferably made of a material with a high thermo-optic coefficient, such as polymer.

In the embodiments of FIG. 7 and FIG. 10, small bending radius waveguides in the ring resonators are required when a spectral response with a large FSR is desired. For instance, a FSR of 50 GHz implies a bending radius smaller than 700 μm. High index contrast waveguides are needed to make the bending losses negligible. High index contrast waveguides can be fabricated by using a high refractive index glass (such as SION) as waveguide core and pure silica as waveguide cladding.

The embodiment of FIG. 3 is a linear passive device, which does not include small bending radius waveguides. It can be realized by using preferably low index contrast waveguides. Single-mode low-index-contrast waveguides may have larger dimension than single-mode high-index-contrast waveguides and the pigtailing to standard optical fiber is facilitated. An example of low index contrast waveguides is given by a germanium doped silica core in a silica cladding (Δn=0.7%).

It is observed that although in the foregoing a preferred embodiment of the invention has been considered, in which the two couplers 101 and 102 are substantially identical in structure, at least some of the optical devices proposed might as well be realized with one of the couplers, e.g. the coupler 101, having only one optical input port, ensuring the 25%/50%/25% power splitting ratio. This is for example the case of the optical interleaver of FIG. 3. In all these cases, the single-input coupler may be realized by means of a three-way Y splitter.

Although the present invention has been disclosed and described by way of some embodiments, it is apparent to those skilled in the art that several modifications to the described embodiments, as well as other embodiments of the present invention are possible without departing from the scope thereof as defined in the appended claims.

1-25. (canceled)

26. An optical device, comprising
an interferometer comprising a first optical coupler, a second optical coupler and at least three arms optically coupling the first optical coupler to the second optical coupler; and
a phase-shifting arrangement associated with said arms,
at least one among the first and second optical couplers comprising a first optical input port, two first optical output ports and a second optical output port, and implementing an optical power coupling such that a first fraction of optical power received at the first optical input port is coupled into each of the first optical output ports, and a second fraction of optical power is coupled into the second optical output port, said at least one among the first and second optical couplers further comprising:
a second optical input port and a third optical input port,
said at least one among the first and second optical couplers implementing an optical power coupling such that:
the first fraction of optical power received at either one of the first or second optical input ports is coupled into each of the first optical output ports, and the second fraction of optical power received at either one of the first or second optical input ports is coupled into the second optical output port, whereas a third fraction of optical power received at the third optical input port is coupled into each of the first optical output ports, and a fourth fraction of optical power received at the third optical input port is coupled into the second optical output port, wherein the first fraction is different from the third fraction.

27. The optical device according to claim 26, wherein the second fraction is different from the fourth fraction.

28. The optical device according to claim 27, wherein said third fraction is substantially 50% and said fourth fraction is substantially 0%, whereby input optical power received at the third optical input port causes substantially equal optical power at the first optical output ports, and substantially zero optical power at the second optical output port

29. The optical device according to claim 28, wherein said first fraction is substantially 25% and said second fraction is substantially 50%.

30. The optical device according to claim 29, wherein each of said first and second optical couplers is bidirectional, whereby a generic input optical port, is also adapted to act as an output optical port, and wee versa, and a generic output optical port is also adapted to act as an input optical port, preserving the optical power coupling.

31. The optical device according to claim 30, wherein each of the first and second optical couplers is designed in such a way that a phase difference between optical fields at the first optical output ports is substantially equal to π, whereas a phase difference between an optical field at either one of the first optical output ports and an optical field at the second optical output port is approximately equal to π/2.

32. The optical device according to claim 31, wherein each of the first and second optical couplers is designed in such a way that the amplitude and the phase of optical fields at the output ports of the coupler are related to those of the optical fields at the input ports by the expression:
$$( \begin{matrix}\frac{1}{2} & \frac{j}{\sqrt{2}} & - \frac{1}{2} \\ \frac{j}{\sqrt{2}} & 0 & \frac{j}{\sqrt{2}} \\ - \frac{1}{2} & \frac{j}{\sqrt{2}} & \frac{1}{2}\end{matrix} ) .$$

33. The optical device according to claim 26, wherein:
said at least three arms comprise a first arm and a second arm coupling a respective one of the two first optical outputs of the first optical coupler to a respective one of the two first optical inputs of the second optical coupler, and a third arm, coupling the second optical output of the first optical coupler to the second optical input of the second optical coupler, and
said phase-shifting arrangement comprises, a respective first, second and third phase shifter, associated with each one of the first, second and third arms, introducing a respective first, second and third phase shift on the component of the input optical signal propagating therethrough.

34. The optical device according to claim 33, wherein each phase shifter comprises a respective optical waveguide section of prescribed optical length.

35. The optical device according to claim 34, wherein the optical waveguide sections forming the phase shifters have mutually different optical lengths.

36. The optical device according to claim 35, wherein the optical lengths of the optical waveguide sections are such that the first phase shift is lower than the third phase shift, which is in turn lower than the second phase shift, a difference between the third and the first phase shifts being substantially equal to a difference between the second and third phase shifts.

37. The optical device according to claim 34, comprising at least one optical ring resonator optically coupled to at least one of said optical waveguide sections.

38. The optical device according to claim 37, wherein said at least one optical ring resonator is optically coupled to the respective optical waveguide section through a two-way directional coupler.

39. The optical device according to claim 37, wherein said at least one optical ring resonator is optically coupled to the optical waveguide section in the third arm.

40. The optical device according to claim 37, wherein said at least one optical ring resonator comprises at least one optical ring resonator optically coupled to each one of the waveguide sections of the first, second and third arms.

41. The optical device according to claim 37, wherein said at least one optical ring resonator comprises at least one series arrangement of a plurality of optical ring resonators optically coupled to the at least one of said optical waveguide sections.

42. The optical device according to claim 37, wherein said at least one optical ring resonator comprises at least one parallel arrangement of a plurality of optical ring resonators optically coupled to the at least one of said optical waveguide sections.

43. The optical device according to claim 34, wherein at least one of said phase shifters comprises a Bragg grating formed within the respective optical waveguide section.

44. The optical device according to claim 43, wherein said Bragg grating has a period such that the grating substantially reflects optical wavelengths in a prescribed band.

45. The optical device according to claim 34, wherein at least one of said phase shifters comprises a controlled heater associated with the respective optical waveguide section for causing a change in a refractive index of the optical waveguide section by thermo-optic effect.

46. The optical device according to claim 45, wherein said controlled heater comprises an electric conductor thermally coupled to the optical waveguide section and adapted to receive a controlled electric power supply.

47. The optical device according to claim 34, wherein at least one of said phase shifters comprises an electrode structure associated with the respective optical waveguide section, and adapted to induce a change in the refractive index of the optical waveguide section by electro-optic effect.

48. The optical device according to claim 34, wherein at least one of said phase shifters comprises a free charge carrier concentration modulation arrangement associated with the respective optical waveguide, and adapted to induce a change in a refractive index of the optical waveguide section by plasma-dispersion effect.

49. The optical device according to claim 34, wherein at least one of said phase shifters has the respective optical waveguide section at least partially made of a non-linear material.

50. The optical device according to claim 49, wherein said phase shifter comprises a semiconductor optical amplifier.
